(19) United States
(12) Patent Application Publication
(10) Pub. No.: US 2024/0340109 A1
(43) Pub. Date: Oct. 10, 2024

(54) CONDITIONAL HYBRID AUTOMATIC REPEAT REQUEST RETRANSMISSION ACROSS CARRIERS

(71) Applicant: QUALCOMM Incorporated, San Diego, CA (US)

(72) Inventors: Diana Maamari, San Diego, CA (US); Iyab Issam Sakhnini, San Diego, CA (US); Hyun Yong Lee, San Diego, CA (US); Mickael Mondet, Louannec (FR)

(21) Appl. No.: 18/296,313

(22) Filed: Apr. 5, 2023

(51) Int. Cl. H04L 1/1812; H04L 5/00; H04W 8/22

(52) U.S. Cl. CPC H04L 1/1816; H04L 5/001; H04W 8/22

(57) ABSTRACT

Methods, systems, and devices for wireless communication are described. In some systems, a user equipment (UE) and a network entity may support conditional cross-carrier hybrid automatic repeat request (HARQ) retransmissions. The UE may transmit a capability message to the network entity to indicate a capability of the UE to support the cross-carrier HARQ retransmissions. The UE or the network entity may transmit a message on a first component carrier. The UE or the network entity may retransmit the message on a second component carrier based on an availability of resources for retransmitting the message, based on the capability of the UE, and based on one or more conditions associated with communications by the UE satisfying a threshold condition for cross-carrier HARQ retransmissions. For uplink communications, the UE may perform the transmitting and conditional retransmitting. For downlink communications, the network entity may perform the transmitting and conditional retransmitting.

### FIELD OF TECHNOLOGY

The following relates to wireless communication, including conditional hybrid automatic repeat request (HARQ) retransmissions across carriers.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some systems, a UE and a network entity may support hybrid automatic repeat request (HARQ) retransmissions, in which a device may retransmit a message based on a failure of a first transmission of the message. HARQ retransmissions may be performed for uplink communications, downlink communications, or both.

### SUMMARY

The described techniques relate to improved methods, systems, devices, and apparatuses that support conditional hybrid automatic repeat request (HARQ) retransmissions across carriers. For example, the described techniques provide for a user equipment (UE) and a network entity to support conditional cross-carrier HARQ retransmissions. The UE may transmit a capability message to the network entity to indicate a capability of the UE to support the cross-carrier HARQ retransmissions. The capability message may indicate that the UE is capable of transmitting uplink cross-carrier HARQ retransmissions or receiving downlink cross-carrier HARQ retransmissions, or both. As an example, the UE or the network entity may transmit an initial message on a first component carrier, which may not be received at another device. The UE or the network entity may retransmit the message on a second component carrier different than the first component carrier based on an availability of resources for retransmitting the message, based on the capability of the UE, and based on one or more conditions associated with communications by the UE satisfying a threshold condition for cross-carrier HARQ retransmissions. If there are available resources on the second component carrier for the retransmission, if the UE supports the cross-carrier HARQ retransmission capability, and if the conditions satisfy the threshold condition, the cross-carrier HARQ retransmission may be enabled or supported. If there are not available resources on the second component carrier for the retransmission, if the UE does not support the cross-carrier HARQ retransmission capability, or if the conditions do not satisfy the threshold condition, the UE or the network entity may refrain from retransmitting on the second component carrier and may instead retransmit the message on the first component carrier. For uplink communications, the UE may perform the transmitting and conditional retransmitting. For downlink communications, the network entity may perform the transmitting and conditional retransmitting.

A method for wireless communication at a UE is described. The method may include transmitting a capability message that indicates a capability of the UE to support cross-carrier HARQ retransmissions, transmitting a message on a first component carrier, and retransmitting the message on a second component carrier different than the first component carrier based on an availability of resources for retransmitting the message, the capability of the UE to support the cross-carrier HARQ retransmissions, and one or more conditions associated with communications by the UE satisfying a threshold condition for the cross-carrier HARQ retransmissions.

An apparatus for wireless communication at a UE is described. The apparatus may include a processor, memory coupled with the processor, and instructions stored in the memory. The instructions may be executable by the processor to cause the apparatus to transmit a capability message that indicates a capability of the UE to support cross-carrier HARQ retransmissions, transmit a message on a first component carrier, and retransmit the message on a second component carrier different than the first component carrier based on an availability of resources for retransmitting the message, the capability of the UE to support the cross-carrier HARQ retransmissions, and one or more conditions associated with communications by the UE satisfying a threshold condition for the cross-carrier HARQ retransmissions.

Another apparatus for wireless communication at a UE is described. The apparatus may include means for transmitting a capability message that indicates a capability of the UE to support cross-carrier HARQ retransmissions, means for transmitting a message on a first component carrier, and means for retransmitting the message on a second component carrier different than the first component carrier based on an availability of resources for retransmitting the message, the capability of the UE to support the cross-carrier HARQ retransmissions, and one or more conditions associated with communications by the UE satisfying a threshold condition for the cross-carrier HARQ retransmissions.

A non-transitory computer-readable medium storing code for wireless communication at a UE is described. The code may include instructions executable by a processor to transmit a capability message that indicates a capability of the UE to support cross-carrier HARQ retransmissions, transmit a message on a first component carrier, and retransmit the message on a second component carrier different than the first component carrier based on an availability of resources for retransmitting the message, the capability of the UE to support the cross-carrier HARQ retransmissions, and one or more conditions associated with communications by the UE satisfying a threshold condition for the cross-carrier HARQ retransmissions.

Some examples of the method, apparatuses, and non-transitory computer-readable medium described herein may further include operations, features, means, or instructions for receiving a control message indicating a threshold uplink delay budget and transmitting a second message indicating whether a remaining uplink delay budget of the UE satisfies the threshold uplink delay budget based on comparing the remaining uplink delay budget with the threshold uplink delay budget.

Some examples of the method, apparatuses, and non-transitory computer-readable medium described herein may further include operations, features, means, or instructions for retransmitting the message on the second component carrier may be based on the second message indicating that the remaining uplink delay budget satisfies the threshold uplink delay budget.

Some examples of the method, apparatuses, and non-transitory computer-readable medium described herein may further include operations, features, means, or instructions for transmitting, via the capability message, an indication of a time period associated with preparing a retransmission of the message on the second component carrier, where retransmitting the message may be based on the time period being less than a threshold time period.

Some examples of the method, apparatuses, and non-transitory computer-readable medium described herein may further include operations, features, means, or instructions for transmitting, via the capability message, an indication of a processing time associated with retransmissions by the UE.

Some examples of the method, apparatuses, and non-transitory computer-readable medium described herein may further include operations, features, means, or instructions for transmitting assistance information that indicates one or more parameters associated with the communications by the UE, where the one or more conditions may be based on the one or more parameters indicated via the assistance information.

In some examples of the method, apparatuses, and non-transitory computer-readable medium described herein, the one or more parameters include a processing time associated with retransmissions by the UE, a status associated with a HARQ buffer at the UE, a quantity of cycles loaded at the UE, a quantity of processors loaded at the UE, or any combination thereof.

In some examples of the method, apparatuses, and non-transitory computer-readable medium described herein, transmitting the assistance information may include operations, features, means, or instructions for transmitting a radio resource control (RRC) message that indicates the one or more parameters associated with the communications by the UE.

Some examples of the method, apparatuses, and non-transitory computer-readable medium described herein may further include operations, features, means, or instructions for transmitting an uplink control information (UCI) message or a medium access control-control element (MAC-CE) that indicates one or more parameters associated with the communications by the UE, where the one or more conditions may be based on the one or more parameters indicated via the UCI message or the MAC-CE.

Some examples of the method, apparatuses, and non-transitory computer-readable medium described herein may further include operations, features, means, or instructions for transmitting assistance information including a request to enable the cross-carrier HARQ retransmissions based on a status associated with one or more processors of the UE satisfying a threshold processor status, where retransmitting the message on the second component carrier may be based on the request.

Some examples of the method, apparatuses, and non-transitory computer-readable medium described herein may further include operations, features, means, or instructions for comparing an uplink packet data convergence protocol (PDCP) queuing delay of the UE to a threshold PDCP queuing delay, transmitting UCI indicating that the uplink PDCP queuing delay satisfies the threshold PDCP queuing delay based on the comparing, the UCI being multiplexed with the message on the first component carrier, and receiving, on the first component carrier, a grant that indicates a transmission occasion for retransmitting the message on the second component carrier, where retransmitting the message may be based on the grant and the uplink PDCP queuing delay satisfying the threshold PDCP queuing delay.

Some examples of the method, apparatuses, and non-transitory computer-readable medium described herein may further include operations, features, means, or instructions for receiving, based on the capability of the UE and the one or more conditions satisfying the threshold condition, a grant that indicates a transmission occasion for retransmitting the message on the second component carrier, where the message may be retransmitted via the transmission occasion on the second component carrier based on the grant.

Some examples of the method, apparatuses, and non-transitory computer-readable medium described herein may further include operations, features, means, or instructions for receiving a control message that configures a set of configured grant resources for HARQ retransmissions on the first component carrier and the second component carrier, the set of configured grant resources including at least a first resource on the first component carrier for transmission of the message and a second resource on the second component carrier for at least one retransmission of the message. In some examples, of the method, apparatuses, and non-transitory computer-readable medium described herein, retransmitting the message may include operations, features, means, or instructions for retransmitting the message via the second resource of the set of configured grant resources based on the capability of the UE and the one or more conditions satisfying the threshold condition.

Some examples of the method, apparatuses, and non-transitory computer-readable medium described herein may further include operations, features, means, or instructions for receiving a control message that configures a semi-static switching pattern for switching between the first component carrier and the second component carrier for at least one retransmission, where retransmitting the message on the second component carrier may be based on the semi-static switching pattern.

Some examples of the method, apparatuses, and non-transitory computer-readable medium described herein may further include operations, features, means, or instructions for receiving, based on transmitting the message, downlink control information (DCI) that indicates a request for a retransmission of the message, where retransmitting the message may be based on the request, and where a carrier indication field in the DCI includes information for the UE that may be different than a carrier indication based on the semi-static switching pattern.

In some examples of the method, apparatuses, and non-transitory computer-readable medium described herein, the one or more conditions include a packet error rate (PER), a reference signal received power (RSRP), or both measured by the UE.

A method for wireless communication at a UE is described. The method may include transmitting a capability message that indicates a capability of the UE to support cross-carrier HARQ retransmissions, receiving a message on a first component carrier, and receiving a retransmission of the message on a second component carrier different than the first component carrier, where receiving the retransmission of the message on the second component carrier is based on the capability of the UE to support the cross-carrier HARQ retransmissions and one or more conditions associated with communications by the UE satisfying a threshold condition for the cross-carrier HARQ retransmissions.

An apparatus for wireless communication at a UE is described. The apparatus may include a processor, memory coupled with the processor, and instructions stored in the memory. The instructions may be executable by the processor to cause the apparatus to transmit a capability message that indicates a capability of the UE to support cross-carrier HARQ retransmissions, receive a message on a first component carrier, and receive a retransmission of the message on a second component carrier different than the first component carrier, where receiving the retransmission of the message on the second component carrier is based on the capability of the UE to support the cross-carrier HARQ retransmissions and one or more conditions associated with communications by the UE satisfying a threshold condition for the cross-carrier HARQ retransmissions.

Another apparatus for wireless communication at a UE is described. The apparatus may include means for transmitting a capability message that indicates a capability of the UE to support cross-carrier HARQ retransmissions, means for receiving a message on a first component carrier, and means for receiving a retransmission of the message on a second component carrier different than the first component carrier, where receiving the retransmission of the message on the second component carrier is based on the capability of the UE to support the cross-carrier HARQ retransmissions and one or more conditions associated with communications by the UE satisfying a threshold condition for the cross-carrier HARQ retransmissions.

A non-transitory computer-readable medium storing code for wireless communication at a UE is described. The code may include instructions executable by a processor to transmit a capability message that indicates a capability of the UE to support cross-carrier HARQ retransmissions, receive a message on a first component carrier, and receive a retransmission of the message on a second component carrier different than the first component carrier, where receiving the retransmission of the message on the second component carrier is based on the capability of the UE to support the cross-carrier HARQ retransmissions and one or more conditions associated with communications by the UE satisfying a threshold condition for the cross-carrier HARQ retransmissions.

Some examples of the method, apparatuses, and non-transitory computer-readable medium described herein may further include operations, features, means, or instructions for transmitting, via the capability message, an indication of a processing time associated with retransmissions by the UE.

Some examples of the method, apparatuses, and non-transitory computer-readable medium described herein may further include operations, features, means, or instructions for transmitting assistance information that indicates one or more parameters associated with communications by the UE, where the one or more conditions may be based on the one or more parameters indicated via the assistance information.

In some examples of the method, apparatuses, and non-transitory computer-readable medium described herein, the one or more parameters include a processing time associated with retransmissions by the UE, a status associated with a HARQ buffer at the UE, a quantity of cycles loaded at the UE, a quantity of processors loaded at the UE, or any combination thereof.

In some examples of the method, apparatuses, and non-transitory computer-readable medium described herein, transmitting the assistance information may include operations, features, means, or instructions for transmitting an RRC message that indicates the one or more parameters associated with the communications by the UE.

Some examples of the method, apparatuses, and non-transitory computer-readable medium described herein may further include operations, features, means, or instructions for transmitting a UCI message or a MAC-CE that indicates one or more parameters associated with the communications by the UE, where the one or more conditions may be based on the one or more parameters indicated via the UCI message or the MAC-CE.

Some examples of the method, apparatuses, and non-transitory computer-readable medium described herein may further include operations, features, means, or instructions for transmitting assistance information including a request to enable the cross-carrier HARQ retransmissions based on a status associated with one or more processors of the UE satisfying a threshold processor status, where receiving the retransmission of the message on the second component carrier may be based on the request.

Some examples of the method, apparatuses, and non-transitory computer-readable medium described herein may further include operations, features, means, or instructions for receiving a grant that schedules a transmission occasion on the second component carrier for the retransmission of the message based on the one or more conditions satisfying the threshold condition, where the retransmission of the message may be received via the transmission occasion on the second component carrier based on the grant.

Some examples of the method, apparatuses, and non-transitory computer-readable medium described herein may further include operations, features, means, or instructions for receiving a control message that configures a semi-static switching pattern for switching between the first component carrier and the second component carrier for at least one retransmission, where receiving the retransmission of the message on the second component carrier may be based on the semi-static switching pattern.

Some examples of the method, apparatuses, and non-transitory computer-readable medium described herein may further include operations, features, means, or instructions for receiving, based on the message, DCI that indicates the retransmission of the message, where receiving the retransmission of the message may be based on the DCI, and where a carrier indication field in the downlink control information includes information for the UE that may be different than a carrier indication based on the semi-static switching pattern.

In some examples of the method, apparatuses, and non-transitory computer-readable medium described herein, the one or more conditions include a PER, an RSRP, or both measured by the UE.

A method for wireless communication at a network entity is described. The method may include receiving a capability message that indicates a capability of a UE to support cross-carrier HARQ retransmissions, receiving a message on a first component carrier, and receiving a retransmission of the message on a second component carrier different than the first component carrier based on an availability of resources for retransmitting the message, the capability of the UE to support the cross-carrier HARQ retransmissions, and one or more conditions associated with communications between the network entity and the UE satisfying a threshold condition for the cross-carrier HARQ retransmissions.

An apparatus for wireless communication at a network entity is described. The apparatus may include a processor, memory coupled with the processor, and instructions stored in the memory. The instructions may be executable by the processor to cause the apparatus to receive a capability message that indicates a capability of a UE to support cross-carrier HARQ retransmissions, receive a message on a first component carrier, and receive a retransmission of the message on a second component carrier different than the first component carrier based on an availability of resources for retransmitting the message, the capability of the UE to support the cross-carrier HARQ retransmissions, and one or more conditions associated with communications between the network entity and the UE satisfying a threshold condition for the cross-carrier HARQ retransmissions.

Another apparatus for wireless communication at a network entity is described. The apparatus may include means for receiving a capability message that indicates a capability of a UE to support cross-carrier HARQ retransmissions, means for receiving a message on a first component carrier, and means for receiving a retransmission of the message on a second component carrier different than the first component carrier based on an availability of resources for retransmitting the message, the capability of the UE to support the cross-carrier HARQ retransmissions, and one or more conditions associated with communications between the network entity and the UE satisfying a threshold condition for the cross-carrier HARQ retransmissions.

A non-transitory computer-readable medium storing code for wireless communication at a network entity is described. The code may include instructions executable by a processor to receive a capability message that indicates a capability of a UE to support cross-carrier HARQ retransmissions, receive a message on a first component carrier, and receive a retransmission of the message on a second component carrier different than the first component carrier based on an availability of resources for retransmitting the message, the capability of the UE to support the cross-carrier HARQ retransmissions, and one or more conditions associated with communications between the network entity and the UE satisfying a threshold condition for the cross-carrier HARQ retransmissions.

Some examples of the method, apparatuses, and non-transitory computer-readable medium described herein may further include operations, features, means, or instructions for transmitting a control message indicating a threshold uplink delay budget and receiving a second message indicating whether a remaining uplink delay budget of the UE satisfies the threshold uplink delay budget, where receiving the retransmission of the message on the second component carrier may be based on the second message indicating that the remaining uplink delay budget satisfies the threshold uplink delay budget.

Some examples of the method, apparatuses, and non-transitory computer-readable medium described herein may further include operations, features, means, or instructions for receiving, via the capability message, an indication of a time period associated with preparation, by the UE, of a retransmission of the message on the second component carrier, the time period based on a processing time associated with retransmissions by the UE, where receiving the retransmission of the message may be based on the time period being less than a threshold time period.

Some examples of the method, apparatuses, and non-transitory computer-readable medium described herein may further include operations, features, means, or instructions for receiving assistance information that indicates one or more parameters associated with the communications by the UE, where the one or more conditions may be based on the one or more parameters indicated via the assistance information.

In some examples of the method, apparatuses, and non-transitory computer-readable medium described herein, the one or more parameters include a processing time associated with retransmissions by the UE, a status associated with a HARQ buffer at the UE, a quantity of cycles loaded at the UE, a quantity of processors loaded at the UE, or any combination thereof.

In some examples of the method, apparatuses, and non-transitory computer-readable medium described herein, receiving the assistance information may include operations, features, means, or instructions for receiving an RRC message that indicates the one or more parameters associated with the communications by the UE.

Some examples of the method, apparatuses, and non-transitory computer-readable medium described herein may further include operations, features, means, or instructions for receiving a UCI message or a MAC-CE that indicates one or more parameters associated with the communications by the UE, where the one or more conditions may be based on the one or more parameters indicated via the UCI message or the MAC-CE.

Some examples of the method, apparatuses, and non-transitory computer-readable medium described herein may further include operations, features, means, or instructions for receiving assistance information including a request to enable the cross-carrier HARQ retransmissions based on a status associated with one or more processors of the UE satisfying a threshold processor status, where receiving the retransmission of the message on the second component carrier may be based on the request.

Some examples of the method, apparatuses, and non-transitory computer-readable medium described herein may further include operations, features, means, or instructions for receiving UCI indicating that an uplink PDCP queuing delay of the UE satisfies a threshold PDCP queuing delay, the UCI being multiplexed with the message on the first component carrier and transmitting, on the first component carrier, a grant that indicates a transmission occasion for the retransmission of the message on the second component carrier, where the retransmission of the message may be received based on the grant and the uplink PDCP queuing delay satisfying the threshold PDCP queuing delay.

Some examples of the method, apparatuses, and non-transitory computer-readable medium described herein may further include operations, features, means, or instructions for transmitting, based on the capability of the UE and the one or more conditions satisfying the threshold condition, a grant that indicates a transmission occasion for the retransmission of the message on the second component carrier, where the retransmission of the message may be received via the transmission occasion on the second component carrier based on the grant.

Some examples of the method, apparatuses, and non-transitory computer-readable medium described herein may further include operations, features, means, or instructions for transmitting a control message that configures a set of configured grant resources for HARQ retransmissions on the first component carrier and the second component carrier, the set of configured grant resources including at least a first resource on the first component carrier for transmission of the message and a second resource on the second component carrier for at least one retransmission of the message, where the retransmission of the message may be received via the second resource of the set of configured grant resources based on the capability of the UE and the one or more conditions satisfying the threshold condition.

Some examples of the method, apparatuses, and non-transitory computer-readable medium described herein may further include operations, features, means, or instructions for transmitting a control message that configures a semi-static switching pattern for switching between the first component carrier and the second component carrier for at least one retransmission, where receiving the retransmission of the message on the second component carrier may be based on the semi-static switching pattern.

Some examples of the method, apparatuses, and non-transitory computer-readable medium described herein may further include operations, features, means, or instructions for transmitting, based on receiving the message, DCI that indicates a request for a retransmission of the message, where receiving the retransmission of the message may be based on the request, and where a carrier indication field in the DCI includes information for the UE that may be different than a carrier indication based on the semi-static switching pattern.

In some examples of the method, apparatuses, and non-transitory computer-readable medium described herein, the one or more conditions include a PER, an RSRP, or both measured by the UE.

A method for wireless communication at a network entity is described. The method may include receiving a capability message that indicates a capability of a UE to support cross-carrier HARQ retransmissions, transmitting a message on a first component carrier, and retransmitting the message on a second component carrier different than the first component carrier, where retransmitting the message on the second component carrier is based on the capability of the UE to support the cross-carrier HARQ retransmissions and one or more conditions associated with communications between the network entity and the UE satisfying a threshold condition for the cross-carrier HARQ retransmissions.

An apparatus for wireless communication at a network entity is described. The apparatus may include a processor, memory coupled with the processor, and instructions stored in the memory. The instructions may be executable by the processor to cause the apparatus to receive a capability message that indicates a capability of a UE to support cross-carrier HARQ retransmissions, transmit a message on a first component carrier, and retransmit the message on a second component carrier different than the first component carrier, where retransmitting the message on the second component carrier is based on the capability of the UE to support the cross-carrier HARQ retransmissions and one or more conditions associated with communications between the network entity and the UE satisfying a threshold condition for the cross-carrier HARQ retransmissions.

Another apparatus for wireless communication at a network entity is described. The apparatus may include means for receiving a capability message that indicates a capability of a UE to support cross-carrier HARQ retransmissions, means for transmitting a message on a first component carrier, and means for retransmitting the message on a second component carrier different than the first component carrier, where retransmitting the message on the second component carrier is based on the capability of the UE to support the cross-carrier HARQ retransmissions and one or more conditions associated with communications between the network entity and the UE satisfying a threshold condition for the cross-carrier HARQ retransmissions.

A non-transitory computer-readable medium storing code for wireless communication at a network entity is described. The code may include instructions executable by a processor to receive a capability message that indicates a capability of a UE to support cross-carrier HARQ retransmissions, transmit a message on a first component carrier, and retransmit the message on a second component carrier different than the first component carrier, where retransmitting the message on the second component carrier is based on the capability of the UE to support the cross-carrier HARQ retransmissions and one or more conditions associated with communications between the network entity and the UE satisfying a threshold condition for the cross-carrier HARQ retransmissions.

Some examples of the method, apparatuses, and non-transitory computer-readable medium described herein may further include operations, features, means, or instructions for receiving, via the capability message, an indication of a processing time associated with retransmissions by the UE.

Some examples of the method, apparatuses, and non-transitory computer-readable medium described herein may further include operations, features, means, or instructions for receiving assistance information that indicates one or more parameters associated with communications by the UE, where the one or more conditions may be based on the one or more parameters indicated via the assistance information.

In some examples of the method, apparatuses, and non-transitory computer-readable medium described herein, the one or more parameters include a processing time associated with retransmissions by the UE, a status associated with a HARQ buffer at the UE, a quantity of cycles loaded at the UE, a quantity of processors loaded at the UE, or any combination thereof.

In some examples of the method, apparatuses, and non-transitory computer-readable medium described herein, receiving the assistance information may include operations, features, means, or instructions for receiving an RRC message that indicates the one or more parameters associated with the communications by the UE.

Some examples of the method, apparatuses, and non-transitory computer-readable medium described herein may further include operations, features, means, or instructions for receiving a UCI message or a MAC-CE that indicates one or more parameters associated with the communications by the UE, where the one or more conditions may be based on the one or more parameters indicated via the UCI message or the MAC-CE.

Some examples of the method, apparatuses, and non-transitory computer-readable medium described herein may further include operations, features, means, or instructions for receiving assistance information including a request to enable the cross-carrier HARQ retransmissions based on a status associated with one or more processors of the UE satisfying a threshold processor status, where retransmitting the message on the second component carrier may be based on the request.

Some examples of the method, apparatuses, and non-transitory computer-readable medium described herein may further include operations, features, means, or instructions for transmitting a grant that schedules a transmission occasion on the second component carrier for a retransmission of the message based on the one or more conditions satisfying the threshold condition, where the message may be retransmitted via the transmission occasion on the second component carrier based on the grant.

Some examples of the method, apparatuses, and non-transitory computer-readable medium described herein may further include operations, features, means, or instructions for transmitting a control message that configures a semi-static switching pattern for switching between the first component carrier and the second component carrier for at least one retransmission, where retransmitting the message on the second component carrier may be based on the semi-static switching pattern.

Some examples of the method, apparatuses, and non-transitory computer-readable medium described herein may further include operations, features, means, or instructions for transmitting, based on the message, DCI that indicates a retransmission of the message, where retransmitting the message may be based on the DCI, and where a carrier indication field in the DCI includes information for the UE that may be different than a carrier indication based on the semi-static switching pattern.

In some examples of the method, apparatuses, and non-transitory computer-readable medium described herein, the one or more conditions include a PER, an RSRP, or both measured by the UE.

### BRIEF DESCRIPTION OF THE DRAWINGS

FIG. 1 shows an example of a wireless communications system that supports conditional hybrid automatic repeat request (HARQ) retransmission across carriers in accordance with one or more aspects of the present disclosure.

FIG. 2 illustrates an example of a wireless communications system that supports conditional HARQ retransmission across carriers in accordance with one or more aspects of the present disclosure.

FIG. 3 illustrates an example of a HARQ transmission timeline that supports conditional HARQ retransmission across carriers in accordance with one or more aspects of the present disclosure.

FIG. 4 illustrates an example of a HARQ transmission timeline that supports conditional HARQ retransmission across carriers in accordance with one or more aspects of the present disclosure.

FIG. 5 illustrates an example of a process flow that supports conditional HARQ retransmission across carriers in accordance with one or more aspects of the present disclosure.

FIG. 6 illustrates an example of a process flow that supports conditional HARQ retransmission across carriers in accordance with one or more aspects of the present disclosure.

FIGS. 7 and 8 illustrate block diagrams of devices that support conditional HARQ retransmission across carriers in accordance with one or more aspects of the present disclosure.

FIG. 9 illustrates a block diagram of a communications manager that supports conditional HARQ retransmission across carriers in accordance with one or more aspects of the present disclosure.

FIG. 10 illustrates a diagram of a system including a device that supports conditional HARQ retransmission across carriers in accordance with one or more aspects of the present disclosure.

FIGS. 11 and 12 illustrate block diagrams of devices that support conditional HARQ retransmission across carriers in accordance with one or more aspects of the present disclosure.

FIG. 13 illustrates a block diagram of a communications manager that supports conditional HARQ retransmission across carriers in accordance with one or more aspects of the present disclosure.

FIG. 14 illustrates a diagram of a system including a device that supports conditional HARQ retransmission across carriers in accordance with one or more aspects of the present disclosure.

FIGS. 15 through 19 illustrate flowcharts showing methods that support conditional HARQ retransmission across carriers in accordance with one or more aspects of the present disclosure.

### DETAILED DESCRIPTION

Some systems may support hybrid automatic repeat request (HARQ) feedback. For example, a user equipment (UE) may receive a downlink message from a network entity and may transmit a feedback message (e.g., HARQ feedback) to indicate feedback in response to the downlink message. If the downlink message is not properly received, the UE may transmit a negative acknowledgment (NACK) to the network entity, and the network entity may perform a retransmission of the downlink message (e.g., a HARQ retransmission). In some systems, the network entity may transmit the downlink message on a first component carrier and may retransmit the downlink message on a second component carrier that is different that the first component carrier. For example, the network entity may retransmit the downlink message in a nearest available downlink transmission opportunity, which may be on a different component carrier than the first component carrier used for the initial transmission. For uplink communications, if a network entity fails to receive an uplink message from the UE, the network entity may transmit an uplink grant that grants resources for a retransmission of the uplink message on the same carrier or a different carrier as the original uplink message. However, cross-carrier HARQ retransmissions may increase complexity and processing by the devices as compared with systems in which the HARQ retransmissions are sent via a same component carrier as the corresponding initial transmission.

Techniques, systems, and devices described herein define conditions or rules for determining when cross-carrier HARQ retransmissions may be enabled or permitted, which may provide for devices to support retransmissions with reduced latency, in some scenarios, while maintaining reduced complexity and processing. A message may be retransmitted on a different component carrier than the initial transmission of the message if a UE that is receiving or transmitting the retransmission is capable of receiving or transmitting cross-carrier retransmissions and if at least one condition associated with communications between the UE and another device satisfies a threshold condition. The condition may be, for example, a delay between packet arrival at a packet delay convergence protocol (PDCP) layer and a transmission of the packet, a reliability measurement (e.g., packet error rate (PER)), a reference signal received power (RSRP), or any combination thereof. The UE may transmit a capability message that indicates whether the UE is capable of supporting cross-carrier retransmissions. The UE may transmit one or more other messages, such as UE assistance information (UAI) or uplink control information (UCI), or both that indicates the condition or one or more parameters for measuring or determining the condition.

The described techniques may be applied for uplink and downlink communications. For downlink communications, the network entity may retransmit a downlink message on a different component carrier if the network entity receives a NACK from the UE in response to an initial transmission of the downlink message, if the UE supports the cross carrier retransmissions, and if the at least one condition is satisfied. For uplink communications, the UE may similarly retransmit an uplink message on a different component carrier if the UE determines that the conditions are satisfied. The UE may receive an uplink grant or some other indication that triggers the retransmission. Time and frequency resources on the different component carrier may be allocated for the cross-carrier retransmissions via dynamic grants, configured grants, or a periodic scheduling pattern.

Aspects of the disclosure are initially described in the context of wireless communications systems. Additional aspects of the disclosure are described with reference to HARQ transmission timelines and process flows. Aspects of the disclosure are further illustrated by and described with reference to apparatus diagrams, system diagrams, and flowcharts that relate to conditional HARQ retransmissions across carriers.

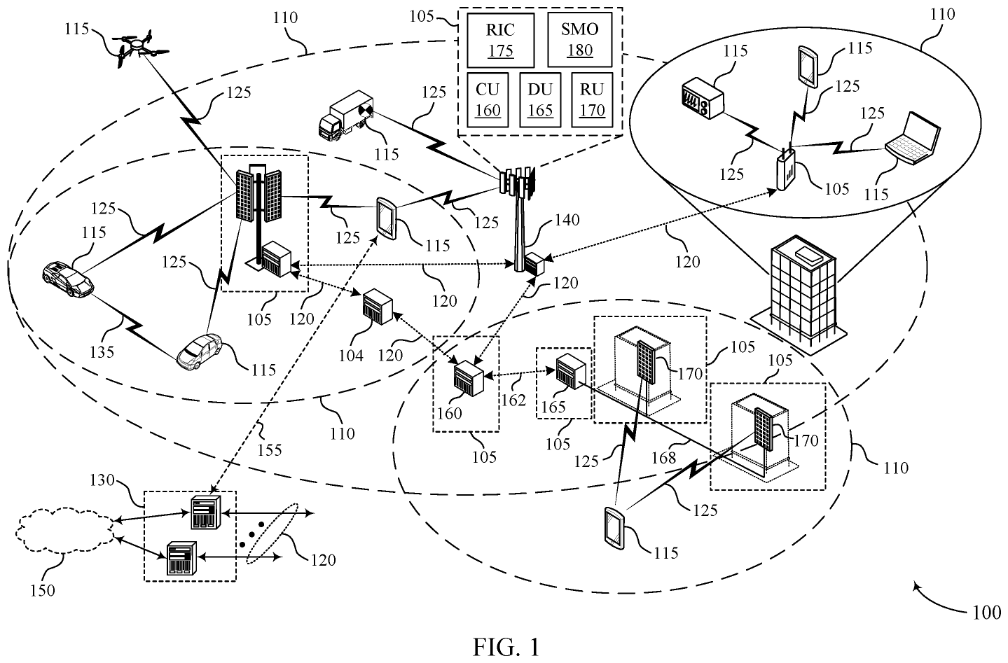

FIG. 1 shows an example of a wireless communications system 100 that supports conditional HARQ retransmission across carriers in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-NB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support conditional HARQ retransmission across carriers as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. HARQ feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

HARQ techniques may thus be used to further increase a reliability of communications between communication devices. HARQ techniques may include retransmitting negatively acknowledged (or unacknowledged) signals using different modulation and/or coding techniques. In such cases, a receiving device may store an unsuccessfully decoded communication (which may be referred to as an initial transmission) and combine the unsuccessfully decoded communication with one or more retransmissions, for example, until the data in the communication is successfully decoded. A HARQ process may support a set of HARQ communications (an initial retransmission and the one or more retransmissions). In some examples, multiple HARQ processes may support multiple sets of HARQ communications between communication devices. For example, one HARQ process may be used to communicate a first set of data and another HARQ process may be used to communicate a second set of data to a device, for example, to increase a data rate of communications between the communication devices. In some examples, acknowledgment feedback used to support a HARQ process may be referred to as HARQ feedback. For downlink transmissions, a HARQ process associated with a transmission and a status of data included in the transmission may be included in a scheduling message (e.g., a DCI message). For uplink transmissions, a HARQ process associated with a transmission and a status of data included in the transmission may be included in an uplink grant (e.g., a DCI message).

For downlink transmissions, HARQ feedback may be reported to a network entity 105 using acknowledgment/negative acknowledgment (ACK/NACK) resources. In some examples, codebook reporting is used to report HARQ feedback for multiple downlink transmissions, and different types of codebook reporting techniques may be configured. In some examples, semi-static reporting (or Type 1 HARQ feedback reporting) may be used to report feedback for a configured quantity of transport blocks. In some examples, dynamic reporting (or Type 2 HARQ feedback reporting) may be used to report feedback for a quantity of transport blocks indicated in downlink control information, for example, using downlink assignment indicators. Both Type 1 and Type 2 HARQ feedback reporting may report HARQ feedback on a transport block (or code group) basis. In some examples, the ordering of the HARQ feedback in the codebook may be based on a timing of the transport blocks. In some examples, one-shot reporting (or Type 3 HARQ feedback reporting) may be used to report feedback for all of the HARQ process configured for a UE 115. Thus, the ordering of HARQ feedback in the codebook may be based on an index of a HARQ process identifier.

In some examples, the ACK/NACK resources may be scheduled based on a downlink shared channel resource used by a downlink transmission. For example, the ACK/NACK resource may occur a designated duration after an end of the downlink shared channel resource. In some examples, the designated duration is based on a higher-layer parameter, which may be referred to as a K1 timing parameter. For communications that use 120 kHz spacing, K1 may correspond to 20 or 24 symbols. For uplink transmissions, the HARQ feedback may be transmitted during uplink shared channel resources scheduled by an uplink grant. In some examples, the uplink shared channel resources may occur a designated duration after an end of the uplink grant. In some examples, the designated duration is given by a second higher-layer parameter, which may be referred to as a K2 timing parameter. For communications that use 120 kHz spacing, K2 may correspond to 36 symbols.

The wireless communications system 100 may support conditional HARQ retransmissions across carriers. For example, the described techniques provide for a UE 115 or a network entity 105, or both to support conditional cross-carrier HARQ retransmissions. In some aspects, the UE 115 may transmit a capability message to the network entity 105 to indicate a capability of the UE 115 to support the cross-carrier HARQ retransmissions. The capability message may indicate that the UE 115 is capable of transmitting uplink cross-carrier HARQ retransmissions, receiving downlink cross-carrier HARQ retransmissions, or both. The UE 115 or the network entity 105 may transmit an initial message on a first component carrier. The UE 115 or the network entity 105 may retransmit the message on a second component carrier different than the first component carrier based on an availability of resources for retransmitting the message, based on the capability of the UE 115, and based on one or more conditions associated with communications by the UE 115 satisfying a threshold condition for cross-carrier HARQ retransmissions. If there are available resources on the second component carrier for the retransmission, if the UE 115 supports the cross-carrier HARQ retransmission capability, and if the conditions satisfy the threshold condition, the cross-carrier HARQ retransmission may be enabled or supported. If there are not available resources on the second component carrier for the retransmission, if the UE 115 does not support the cross-carrier HARQ retransmission capability, or if the conditions do not satisfy the threshold condition, or any combination thereof, the device may refrain from retransmitting on the second component carrier and may instead retransmit the message on the first component carrier. For uplink communications, the UE 115 may perform the transmitting and conditional retransmitting. For downlink communications, the network entity 105 may perform the transmitting and conditional retransmitting.

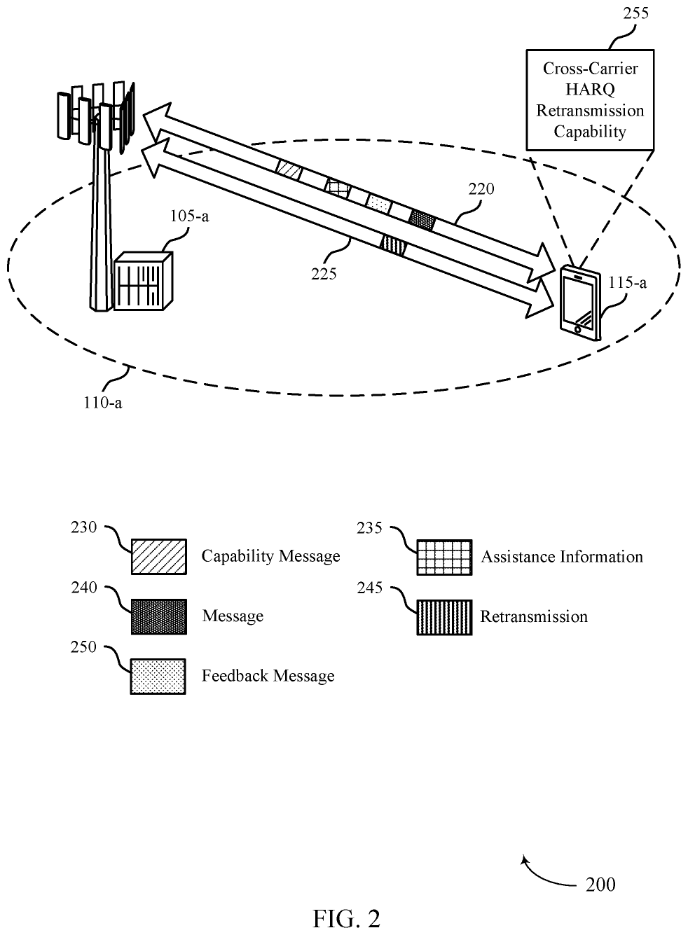

FIG. 2 illustrates an example of a wireless communications system 200 that supports conditional HARQ retransmissions across carriers in accordance with one or more aspects of the present disclosure. The wireless communications system 200 may implement or be implemented by aspects of the wireless communications system 100. For example, the wireless communications system 200 includes a network entity 105-a and a UE 115-a, which may represent examples of a network entity 105 and a UE 115 as described with reference to FIG. 1. The network entity 105-a and the UE 115-a may communicate within a geographic coverage area 110-a and via one or more communication links 220 and 225, which may represent examples of component carriers or cells in some examples herein. In this example, the network entity 105-a and the UE 115-a may utilize one or more rules or procedures for determining when to perform cross-carrier HARQ retransmissions.

The wireless communications system 200 may support HARQ feedback and retransmissions of data to increase the likelihood that data is received successfully. HARQ may include a combination of error detection (e.g., using a CRC), FEC, and retransmission. For example, the network entity 105-a may transmit a message 240 (e.g., a downlink message) to the UE 115-a via the communication link 220. The UE 115-a may monitor for the message 240. The UE 115-a may transmit a feedback message 250 in response to the message 240. The feedback message 250 may be a HARQ feedback message that may indicate whether the downlink message 240 was received and decoded properly by the UE 115-a. If the feedback message 250 indicates an ACK, the message 240 may have been received and decoded by the UE 115-a. If the feedback message 250 indicates a NACK, the message 240 may not have been received and/or decoded by the UE 115-a. The network entity 105-a may transmit a retransmission 245 of the message 240 based on the feedback message 250. For example, a NACK may trigger or indicate a request for a retransmission of the message 240.

HARQ retransmissions may similarly be applied for uplink communications. For example, the UE 115-a may transmit a message 240 to the network entity 105-a. If the network entity 105-a does not receive or decode the message 240, the network entity 105-a may transmit feedback in the form of an uplink grant or other message that indicates resources scheduled for a retransmission 245 of the message 240. The UE 115-a may accordingly transmit the retransmission 245.

In some examples, a retransmission 245 of the message 240 may be on a same component carrier or same cell as the initial transmission of the message 240. For example, the UE 115-a may transmit the message 240 via the communication link 220 (e.g., a primary cell (PCell)) and may transmit the retransmission 245 via the same communication link 220. In such cases, the devices may wait for a next available or unused transmission occasion on the component carrier to perform the retransmission 245, which may increase latency and decrease throughput and reliability of the communications. That is, TDD patterns for HARQ retransmissions 245 may increase delays, which may compromise latency and reliability (e.g., key performance indicators (KPIs) for some scenarios, such as extended reality communications and applications).

To shorten the retransmission time for HARQ retransmissions 245, some devices may support HARQ retransmissions 245 on different component carriers. In such cases, the devices may utilize a nearest or earliest uplink opportunity (e.g., available transmission occasion) on any carrier for an uplink transmission and a nearest or earliest downlink opportunity (e.g., available transmission occasion) on any carrier for a downlink transmission to reduce latency. The initial message 240 may be transmitted on a first component carrier. If a next available transmission occasion is on a different component carrier, then, in some examples, the associated HARQ retransmission 245 may be transmitted on the different component carrier to reduce latency (e.g., to refrain from waiting for a next available transmission occasion on the first carrier). In the example of FIG. 2, the UE 115-a may transmit the message 240 (e.g., a first physical uplink shared channel (PUSCH)) on the first communication link 220 (e.g., a first component carrier or a PCell) and may transmit the retransmission 245 for the message 240 on the second communication link 225 (e.g., a second component carrier or a secondary cell (SCell), or some other type of cell).

In some cases, generating and transmitting a retransmission 245 on a different component carrier than an initial transmission may increase complexity, processing, and power consumption. For example, cross-carrier retransmissions 245 may impact modem firmware because HARQ-related operations may be specified per component carrier, for some devices and communication systems. Additionally, or alternatively, time periods for building or generating a transmission (e.g., PUSCH processing and preparation times, or physical downlink shared channel (PDSCH) processing and preparation times) as well as HARQ buffer limitations may be relatively large for cross-carrier retransmissions as compared with same-carrier retransmissions. In some examples, implementation by a receiving device, such as a network entity 105 in the case of uplink communications, may be impacted by cross-carrier retransmissions 245 due to, for example, combining soft values on different component carriers. As such, constant cross-carrier retransmissions 245 may negatively impact communication throughput, reliability, and efficiency.

Techniques, systems, and devices described herein provide for conditions and protocols that define when cross-carrier HARQ retransmissions 245 may be performed, which may provide for the devices to achieve reduced latency by using cross-carrier retransmissions 245 in some scenarios while maintaining reduced processing complexity and power consumption on average over multiple communication scenarios. As described herein, a grant for a retransmission 245 may be provided for a same cell or a different cell based on a capability of the UE 115-a, an availability of resources for retransmissions 245, and one or more conditions associated with communications by the UE 115-a satisfying a respective threshold condition, as indicated via UE assistance information 235 and other UE feedback.

The UE 115-a may support the cross-carrier HARQ retransmission capability 255, which may indicate that the UE 115-a is capable of transmitting and/or receiving a retransmission 245 of a message 240 on a different component carrier than a component carrier used for transmission and/or reception of the message 240. The cross-carrier HARQ retransmission capability 255 may be based on a configuration of the UE 115-a (e.g., may be pre-defined or configured during manufacture). The UE 115-a may transmit a capability message 230 to the network entity 105-a that indicates whether the UE 115-a supports the cross-carrier HARQ retransmission capability 255. In some examples, for uplink communications, the UE 115-a may report, via the capability message 230, a capability of how fast the UE 115-a may build a PUSCH retransmission 245 on a different component carrier. For example, an assistance information element (IE) in the capability message 230 (e.g., a UEinformationCapabilityIE, or some other IE) may be configured to indicate the uplink transmission preparation time period supported by the UE 115-a and may assist the network entity 105-a in determining or deciding whether to enable cross-carrier retransmissions 245 or schedule a switch between component carriers for a retransmission 245 by the UE 115-a.

The UE 115-a may transmit UE assistance information 235 to the network entity 105-a to indicate one or more parameters associated with communications by the 115-a. The one or more parameters may include a processing time associated with retransmissions by the UE 115-a (e.g., a processing time for building a PUSCH retransmission 245 on a different component carrier), a status associated with a HARQ buffer of the UE 115-a (e.g., a HARQ buffer limitation), a quantity of cycles loaded at the UE 115-a, a quantity of processors loaded at the UE 115-a, one or more other parameters, or any combination thereof. In some examples, the assistance information 235 may additionally, or alternatively, indicate a request to enable cross-carrier HARQ retransmissions 245. That is, the UE 115-a may explicitly request an enable or disable of the HARQ cross-carrier retransmission feature based on one or more parameters or metrics at the UE 115-a, such as an internal processor load at the UE 115-a or some other parameter. The UE assistance information 235 may be transmitted via RRC signaling, via UCI, via a MAC-CE, or any combination thereof. In some examples, the parameters associated with the communications by the UE 115-a may change relatively quickly (e.g., processing load, a waiting time of uplink packets, etc.). In such cases, the MAC-CE or UCI transmission for the assistance information 235 may be beneficial to reduce latency of reporting the parameters.

In some examples, the UE 115-a may determine an uplink packet data convergence protocol (PDCP) queuing delay of the UE 115-a, which may correspond to a delay between arrival of a packet at a PDCP layer until an uplink grant to transmit the packet. The UE 115-a may compare the uplink PDCP queuing delay with a threshold PDCP queuing delay. The network entity 105-a may transmit control signaling that configures the threshold uplink PDCP queuing delay for cross-carrier retransmissions 245. The UE 115-a may transmit UCI to the network entity 105-a to indicate whether the uplink PDCP queuing delay exceeds the threshold. In some examples, the UCI may include or represent an example of the assistance information 235 (e.g., the UCI may be multiplexed on a same initial PUSCH or physical uplink control channel (PUCCH) to indicate UE feedback).

The UE 115-a may be granted an uplink grant on a switched component carrier for a HARQ retransmission 245 conditionally if the uplink PDCP queuing delay exceeds the threshold (e.g., if the condition is true, the UE feedback may be favorable for a component carrier switch). For example, if a packet has been in the buffer of the UE 115-a for a relatively long period of time, the network entity 105-a may transmit an uplink grant to the UE 115-a on the serving cell to indicate an earliest transmission occasion, which may be a transmission occasion on a second component carrier (e.g., the communication link 225) for the retransmission 245. If the uplink PDCP queuing delay does not exceed the threshold, the network entity 105-a may schedule the retransmission 245 on a same component carrier as the initial transmission of the message 240 (e.g., if the condition is false, the UE feedback may not be favorable for a switch between component carriers).

In some examples, the network entity 105-a may transmit a control message or other signaling to the UE 115-a to configure the UE 115-a with a threshold uplink delay budget (e.g., a delay bound threshold) for cross-carrier retransmissions 245. The UE 115-a may dynamically (e.g., at one or more periodic or semi-periodic time intervals) compare a remaining uplink delay budget at the UE 115-a with the threshold uplink delay budget. The UE 115-a may transmit an indication to the network entity 105-a to indicate whether the remaining uplink delay budget exceeds the threshold. The indication may be conveyed via the UE assistance information 235 or some other message transmitted by the UE 115-a (e.g., a one-bit indication indicating whether the threshold uplink delay budget is satisfied). If the threshold uplink delay budget is satisfied, the condition may be favorable for cross-carrier HARQ retransmissions 245. For example, if the UE 115-a indicates that the remaining uplink delay budget at the UE 115-a exceeds the threshold, the network entity 105-a may transmit an uplink grant that schedules a retransmission 245 during an earliest available transmission occasion to reduce latency, which may be on a different component carrier.

The network entity 105-a may thereby transmit a dynamic grant that schedules a retransmission 245 of a message 240 by the UE 115-a on a different component carrier if an earliest available transmission occasion is on the different component carrier, if one or more configured conditions at the UE 115-a are satisfied, and if the UE 115-a supports the cross-carrier HARQ retransmission capability 255. If all of these conditions are met, the cross-carrier retransmission 245 may reduce latency and improve reliability of communications. If the conditions are not met, or if the UE 115-a does not support the cross-carrier HARQ retransmission capability 255, a cross-carrier retransmission 245 may not be beneficial for communication reliability, and the network entity 105-a may instead schedule a retransmission 245 on the same carrier as the initial message 240.

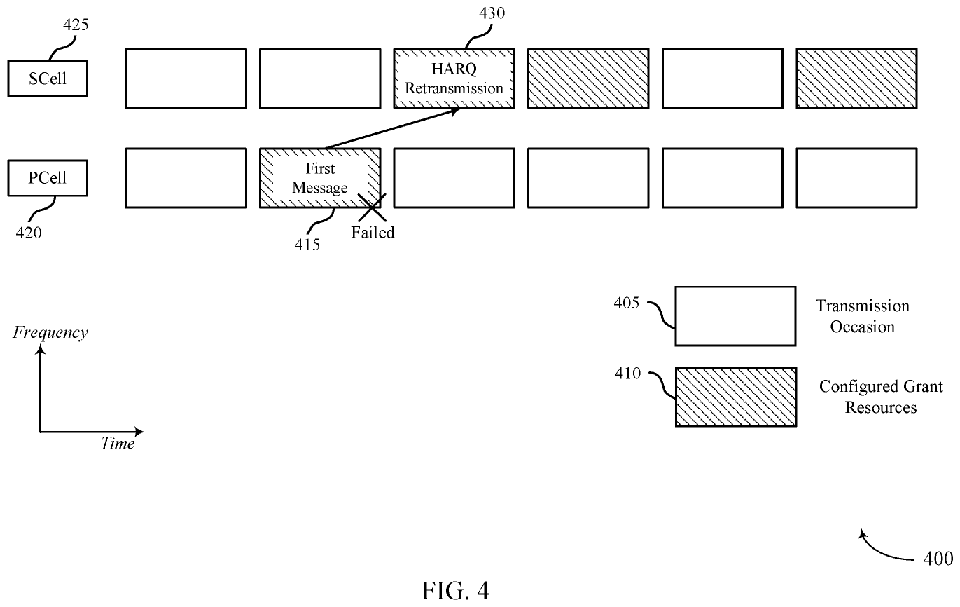

In some examples, the network entity 105-a may transmit control signaling to the UE 115-a to configure one or more configured grants. The configured grants may indicate resources on one or more cells that are allocated for transmissions and retransmissions 245 by the UE 115-a. The UE 115-a may autonomously perform a retransmission 245 in an earliest available transmission occasion that includes configured grant resources. If the earliest occasion is on a different component carrier than an initial transmission, the UE 115-a may determine whether to switch to the different component carrier based on the UE capability and the one or more conditions, as described in further detail elsewhere herein, including with reference to FIG. 4.

For downlink communications, the network entity 105-a may determine whether to retransmit a message 240 on a different component carrier based on the parameters indicated via the capability message 230 and the UE assistance information 235 as compared with the threshold parameters described herein, based on the UE capability, and based on an availability of resources for cross-carrier retransmissions. The network entity 105-a may transmit a dynamic grant that schedules a retransmission 245 of a message 240 by the network entity 105-a on a different component carrier if an earliest available transmission occasion is on the different component carrier, if one or more configured conditions at the UE 115-a are satisfied, and if the UE 115-a supports the cross-carrier HARQ retransmission capability 255. If all of these conditions are met, the cross-carrier retransmission 245 may reduce latency and improve reliability of communications. If the conditions are not met, or if the UE 115-a does not support the cross-carrier HARQ retransmission capability 255, a cross-carrier retransmission 245 may not be beneficial for communication reliability, and the network entity 105-a may instead schedule a retransmission 245 on the same carrier as the initial message 240.

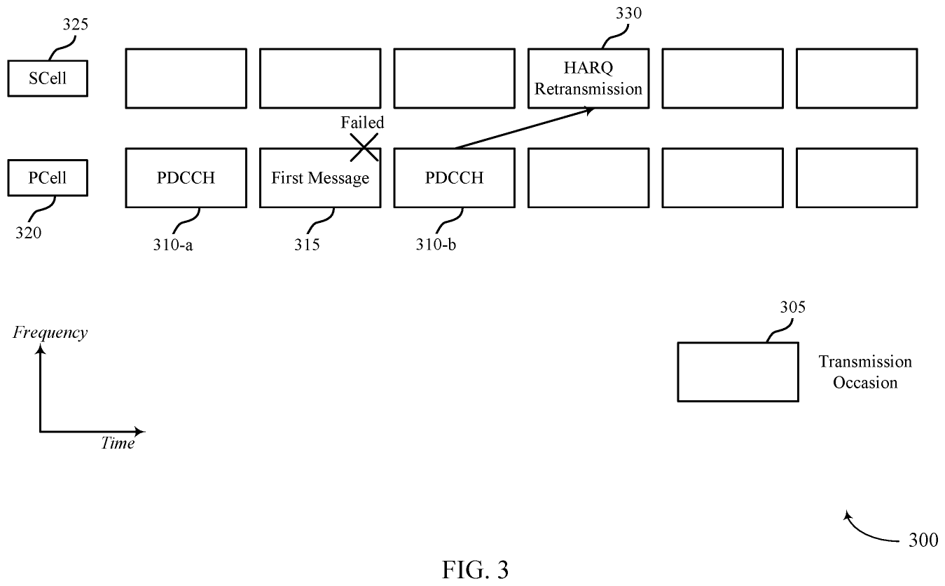

In some examples, the network entity 105-a may indicate a semi-static switching pattern for switching between component carriers. The pattern may indicate, for example, a quantity of retransmissions 245 that may be performed for a given message 240, and a pattern of component carriers that may be followed when performing the retransmissions 245. In such cases, the UE 115-a and the network entity 105-a may switch between carriers for retransmissions 245 in accordance with the pattern, as described in further detail elsewhere herein, including with reference to FIG. 3.

The UE 115-a and the network entity 105-a may thereby support conditional cross-carrier HARQ retransmissions 245 for uplink and downlink communications. By following the described protocols for determining whether and when to switch component carriers for a retransmission, the devices may balance reduced latency with reduced processing complexity and power consumption to improve communication throughput and reliability.

FIG. 3 illustrates an example of a HARQ transmission timeline 300 that supports conditional HARQ retransmission across carriers in accordance with one or more aspects of the present disclosure. The HARQ transmission timeline 300 may implement or be implemented by aspects of the wireless communications systems 100 and 200, in some examples. For example, the HARQ transmission timeline 300 illustrates a timeline for HARQ retransmissions across different component carriers or cells (e.g., a PCell 320 and an SCell 325). The HARQ transmission timeline 300 may apply to uplink communications, downlink communications, or both between a UE 115 and a network entity 105, which may represent examples of a UE 115 and a network entity 105 as described with reference to FIGS. 1 and 2.

In the example of FIG. 3 as applied to uplink communications, a UE 115 may perform communications with a network entity 105 via one or more cells, including the PCell 320 and the SCell 325. The UE 115 may receive a control message or grant via a physical downlink control channel (PDCCH) 310-a on the PCell 320. The network entity 105 may transmit an uplink grant or some other control message via the PDCCH 310-a. The PDCCH 310-a may indicate a transmission occasion 305 for transmission, by the UE 115, of a message 315. The transmission occasion 305 may represent a set of one or more time and frequency resources on the PCell 320 that are allocated or reserved for transmission of the message 315. In this example, the message 315 may fail. For example, the network entity 105 may not receive the message 315 or the message 315 may be corrupted due to interference or other factors. The network entity 105 may transmit a second PDCCH 310-b that conveys a second uplink grant or other control message that allocates time and frequency resources within a second transmission occasion 305 for a HARQ retransmission 330 based on the failure of the message 315. As part of a HARQ procedure, the UE 115 may retransmit the message 315 as a HARQ retransmission 330 based on the PDCCH 310-b to improve throughput and reliability.

In some cases, as described with reference to FIG. 2, the UE 115 may retransmit the message 315 on the PCell 320 (e.g., on the same cell or component carrier). If a transmission occasion 305 is available on a different cell, such as the SCell 325, earlier in time than an available transmission occasion 305 on the PCell 320, the UE 115 may reduce latency if the UE 115 switches carriers to perform the retransmission. However, cross-carrier HARQ retransmissions 330 may increase processing and preparation latency, may increase complexity and power consumption, and may reduce reliability. For example, cross-carrier HARQ retransmissions 330 may, in some examples, increase UE complexity, may increase delays in building or generating a PUSCH or PDSCH message, and may increase HARQ buffer limitations. Additionally, or alternatively, cross-carrier HARQ retransmissions 330 may impact modem firmware at the UE 115, the network entity 105, or both, given that HARQ-related operations may be specified per component carrier, in some examples. In some examples, cross-carrier HARQ retransmissions 330 may impact implementation at the network entity 105 (e.g., gNB implementations), due to, for example, combining soft values on different carriers at the network entity 105. Accordingly, it may be beneficial to reduce cross-carrier HARQ retransmissions 330 to balance reduced latency with improved reliability and throughput and reduced processing complexity.

Techniques, systems, and devices described herein define conditions and protocols for performing cross-carrier or cross-cell HARQ retransmissions 330. As described herein, either uplink or downlink messages may be retransmitted on a different component carrier if a UE 115 that is receiving or transmitting the message supports a capability for cross-carrier HARQ retransmissions, if one or more conditions associated with communications by the UE 115 satisfy a threshold condition, and based on availability of resources for the cross-carrier retransmission. The UE capability and feedback may represent examples of the capability message 230, the assistance information 235, and one or more other messages, as described in further detail elsewhere herein, including with reference to FIG. 2. The UE 115 may transmit the capability message and assistance information before or at the same time as the PDCCH 310-a, the message 315, the PDCCH 310-b, or any combination thereof.

For uplink communications, a UE 115 may transmit the first message 315 as an uplink message on the PCell 320 (e.g., a first component carrier). The first message 315 may be transmitted to a network entity 105 via a scheduled transmission occasion 305, which may be a set of time and frequency resources allocated for transmission of the message 315. The message 315 may be scheduled by an uplink grant transmitted via a PDCCH 310-a (e.g., a prior transmission occasion 305).

If the first message 315 fails (e.g., if the network entity 105 does not receive and/or decode the message 315), the UE 115 may transmit a HARQ retransmission 330. In the example of FIG. 3, the HARQ retransmission 330 may be transmitted on a different component carrier than the initial message 315. For example, the message 315 may be transmitted on the PCell 320 and the retransmission 330 may be transmitted on the SCell 325. The UE 115 may perform the cross-carrier HARQ retransmission based on a capability of the UE 115 to support cross-carrier retransmissions, based on UE feedback that indicates one or more conditions associated with communications by the UE 115 satisfy a threshold condition, and based on an availability of uplink resources or transmission occasions 305.

In some examples, the UE 115 may be conditionally granted an uplink grant on a switched carrier for HARQ retransmission 330. The network entity 105 may determine that the conditions for cross-carrier retransmission are met and may transmit an uplink grant via the PDCCH 310-b that schedules or allocates a set of time and frequency resources in a transmission occasion 305 on the SCell 325 for the retransmission 330. The transmission occasion 305 on the SCell 325 may be a nearest or earliest available transmission occasion, in some examples. For example, a next consecutive transmission occasion after the PDCCH 310-b on the PCell 320 may not be available, and the network entity 105 may determine to schedule the cross-carrier retransmission 330 to reduce latency. The network entity 105 may determine that the conditions are met based on the capability message received from the UE 115, the assistance information received from the UE 115, one or more other messages received from the UE 115 that indicate conditions associated with communications at the UE 115, and a set of threshold conditions configured for cross-carrier retransmissions.

In some other examples, the network entity 105 may configure a set of configured grant resources for transmissions by the UE 115. In such cases, the UE 115 may autonomously perform cross-carrier retransmission during the configured grant resources based on the conditions for cross-carrier retransmissions being satisfied, as described in further detail elsewhere herein, including with reference to FIG. 4.

For downlink communications, a network entity 105 may transmit the first message 315 as a downlink message on the PCell 320 (e.g., a first component carrier). The first message 315 may be transmitted to a UE 115 via a scheduled transmission occasion 305, which may be a set of time and frequency resources allocated for transmission of the message 315. The message 315 may be scheduled by a dynamic grant transmitted via a PDCCH 310-a (e.g., a prior transmission occasion 305).

If the first message 315 fails (e.g., if the UE 115 does not receive and/or decode the message 315 adequately), the network entity 105 may transmit a HARQ retransmission 330. In the example of FIG. 3, the HARQ retransmission 330 may be transmitted on a different component carrier than the initial message 315. For example, the message 315 may be transmitted on the PCell 320 and the retransmission 330 may be transmitted on the SCell 325. The network entity 105 may perform the cross-carrier HARQ retransmission based on a capability of the UE 115 to support cross-carrier retransmissions, based on UE feedback that indicates one or more conditions associated with communications by the UE 115 satisfy a threshold condition, and based on an availability of uplink resources or transmission occasions 305. In some examples, the UE 115 may transmit a NACK or other feedback message in response to the message 315 that indicates that the message 315 was not received and/or decoded properly. The network entity 105 may be prompted to perform the retransmission 330 based on the NACK.

The network entity 105 may conditionally grant resources on the SCell 325 for the cross-carrier HARQ retransmission 330. The network entity 105 may determine that the conditions for cross-carrier retransmission are met and may transmit a dynamic grant (e.g., DCI) via the PDCCH 310-b that schedules or allocates a set of time and frequency resources in a transmission occasion 305 on the SCell 325 for the retransmission 330. The transmission occasion 305 on the SCell 325 may be a nearest or earliest available transmission occasion, in some examples. For example, a next consecutive transmission occasion after the PDCCH 310-b on the PCell 320 may not be available, and the network entity 105 may determine to schedule the cross-carrier retransmission 330 to reduce latency. The network entity 105 may determine that the conditions are met based on the capability message received from the UE 115, the assistance information received from the UE 115, one or more other messages received from the UE 115 that indicate conditions associated with communications at the UE 115, and a set of threshold conditions configured for cross-carrier retransmissions.

In some examples, a quantity of retransmissions 330 by the network entity 105 for downlink communications, by the UE 115 for uplink communications, or both may be limited (e.g., for communication flows with relatively tight delay budget, such as extended reality). In such cases, the network entity 105 may transmit control signaling to the UE 115 that configures a semi-static switching pattern for initial transmission of the message 315 and retransmission(s) 330. For example, if a packet delay budget is ten milliseconds, a single retransmission 330 may be performed in addition to an initial transmission, and the semi-static switching pattern may be PCell 320 to SCell 325 (e.g., PCC-SCC). In some other examples, multiple retransmissions 330 may be permitted, and the semi-static switching pattern may indicate a pattern of one or more different cells for each transmission. In the example of FIG. 3, the network entity 105 may configure the semi-static switching pattern (e.g., via RRC signaling or some other type of signaling) before transmitting the PDCCH 310-a. The semi-static switching pattern may be PCell 320 to SCell 325, such that the initial message 315 is transmitted on the PCell 320 and the UE 115 may know to switch to the SCell 325 to perform the retransmission 330 for uplink communications or to monitor for the retransmission 330 for downlink communications.

If the network entity 105 configures a semi-static switching pattern for cross-carrier HARQ retransmissions 330, the network entity 105 may repurpose one or more fields or bits in the PDCCH 310-b. For example, a DCI transmitted via the PDCCH 310-b may indicate that a retransmission 330 is to occur, but may not indicate a carrier for the retransmission 330, as the UE 115 may know the carrier is the SCell 325 based on the semi-static switching pattern. Thus, one or more bits configured for the carrier indication (e.g., a ‘Carrier Indicator’ field) may be repurposed for some other indication or information. For example, the network entity 105 may include additional bits for one or more other fields in the DCI, such as additional time domain resource allocation information, additional frequency domain resource allocation information, or some other type of information for the UE 115.

A network entity 105 and a UE 115 as described herein may thereby perform conditional cross-carrier HARQ retransmissions 330. By defining threshold conditions and protocols for when to perform cross-carrier HARQ retransmissions 330, the devices may perform cross-carrier HARQ retransmissions for reduced latency communications or communication flows associated with a relatively low latency and/or high priority, and the devices may reduce processing complexity and power consumption by performing HARQ retransmissions on a same carrier in other scenarios.

FIG. 4 illustrates an example of a HARQ transmission timeline 400 that supports conditional HARQ retransmission across carriers in accordance with one or more aspects of the present disclosure. The HARQ transmission timeline 400 may implement or be implemented by aspects of the wireless communications systems 100 and 200 and the HARQ transmission timeline 300, as described with reference to FIGS. 1-3. For example, the HARQ transmission timeline 400 illustrates a timeline for HARQ retransmissions across different component carriers or cells (e.g., a PCell 420 and an SCell 425). The HARQ transmission timeline 400 may apply to uplink communications between a UE 115 and a network entity 105, which may represent examples of a UE 115 and a network entity 105 as described with reference to FIGS. 1-3.

In this example, the network entity 105 may transmit a control message, such as an RRC configuration, or some other type of control signaling, that configures one or more configured grant resources 410 across one or more of the PCell 420 and the SCell 425. The configured grant resources 410 may be time and frequency resources in one or more transmission occasions 405 that are allocated for uplink transmissions by the UE 115. The control message may indicate the time and frequency resource allocations of the configured grant resources 410 to the UE 115.

If the UE 115 receives an indication of the configured grant resources 410, the UE 115 may perform transmissions and retransmissions autonomously (e.g., with or without receiving dynamic grants via a DCI or other PDCCH from the network entity 105) based on one or more conditions and/or capabilities of the UE 115. For example, the UE 115 may transmit the message 415 (e.g., a first message 415) via a first available transmission occasion 405 including configured grant resources 410. The first message 415 may be transmitted on the PCell 420, in this example. If the first message fails (e.g., is not properly transmitted, received, or decoded), the UE 115 may transmit a HARQ retransmission 430 in a next available transmission occasion 405.

In the example of FIG. 4, the next available transmission occasion 405 that includes configured grant resources 410 after the first message 415 may be on the SCell 425 (e.g., a transmission occasion 405 at the same time on the PCell 420 may be reserved for other communications or otherwise unavailable for configured grant resources 410). As described herein, if one or more conditions for cross-carrier HARQ retransmissions 430 are met, the UE 115 may autonomously determine to perform a cross-carrier retransmission 430 via the next or earliest available configured grant resources 410 on the SCell 425.

If the UE 115 does not support the cross-carrier HARQ retransmission capability, the UE 115 may not perform cross-carrier HARQ retransmissions 430, and the UE 115 may instead wait until a next available transmission occasion 405 including configured grant resources 410 occurs on the PCell 420. However, if the UE 115 does support the cross-carrier HARQ retransmission capability, the UE 115 may compare one or more parameters indicative of conditions for communications at the UE 115 with one or more thresholds for cross-carrier HARQ retransmissions. The conditions may be, for example, an uplink delay bound of the UE 115, a retransmission preparation timing capability of the UE 115, a processing time supported by the UE 115, a HARQ buffer status, a quantity of loaded cycles or processors at the UE 115, a PDCP queuing delay at the UE 115, or any combination thereof. If the UE 115 determines that one or more of the conditions satisfy a respective threshold condition, and the UE 115 supports the cross-carrier HARQ retransmission capability, the UE 115 may switch to the SCell 425 to transmit the HARQ retransmission 430 via the configured grant resources 410. The UE 115 may receive control signaling that indicates or configures the conditions and corresponding thresholds, as described in further detail elsewhere herein, including with reference to FIG. 2.

The UE 115 may thereby autonomously determine whether to retransmit a message on a same component carrier as the initial transmission of the message or on a different component carrier based on a UE capability and one or more conditions as described herein. By limiting or reducing cross-carrier retransmissions, the UE 115 may reduce processing complexity and power consumption while still supporting cross-carrier retransmissions when beneficial, such as for relatively low latency communications.

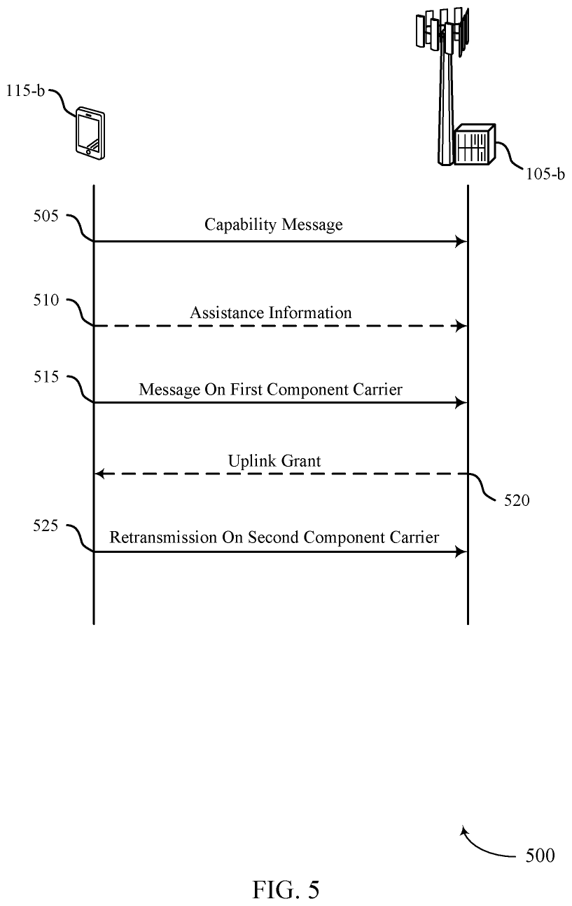

FIG. 5 illustrates an example of a process flow 500 that supports conditional HARQ retransmission across carriers in accordance with one or more aspects of the present disclosure. The process flow 500 may implement or be implemented by aspects of the wireless communications systems 100 and 200 and the HARQ transmission timelines 300 and 400, as described with reference to FIGS. 1-4. For example, the process flow 500 illustrates communications between a UE 115-b and a network entity 105-b, which may represent examples of a UE 115 and a network entity 105 as described with reference to FIGS. 1-4. In this example, the UE 115-b may retransmit a message to the network entity 105-b on a different component carrier than the initial transmission of the message based on a capability of the UE 115-b and one or more conditions associated with communications by the UE 115-b.

In the following description of the process flow 500, the operations between the UE 115-b and the network entity 105-b may be performed in different orders or at different times. Some operations may also be left out of the process flow 500, or other operations may be added. Although the UE 115-b and the network entity 105-b are shown performing the operations of the process flow 500, some aspects of some operations may also be performed by one or more other wireless devices.

At 505, the UE 115-b may transmit a capability message to the network entity 105-b. The capability message may indicate a capability of the UE 115-b to support cross-carrier HARQ retransmissions. In this example, the UE 115-b may support retransmissions of messages on different component carriers (e.g., retransmissions on a component carrier different from a component carrier used for an initial transmission). The capability message may represent an example of a capability message 230, as described with reference to FIG. 2. In some examples, the capability message may convey an indication of a time period associated with preparing a retransmission of a message on a different component carrier, or an indication of a processing time associated with retransmissions by the UE 115-b on a different component carrier, or both.

At 510, in some examples, the UE 115-b may transmit assistance information to the network entity 105-b. The assistance information may indicate one or more parameters associated with communications by the UE 115-b (e.g., communications between the UE 115-b and the network entity 105-b, or between the UE 115-b and one or more other devices). The one or more parameters may include, for example, a processing time associated with retransmissions by the UE 115-b, a status associated with a HARQ buffer at the UE 115-b, a quantity of cycles loaded at the UE 115-b, a quantity of processors loaded at the UE 115-b, or any combination thereof. The assistance information may be transmitted, for example, via an RRC message. Additionally, or alternatively, the one or more parameters may be transmitted via UCI, via a MAC-CE, or any combination thereof. In some examples, the parameters or criteria may change relatively quickly. As such, the UCI or MAC-CE may be relatively quicker (e.g., more frequent) than the RRC message, which may reduce latency associated with informing the network entity 105-b of the conditions at the UE 115-b.

At 515, the UE 115-b may transmit a message to the network entity 105-b on a first component carrier. The message may be an uplink message. The first component carrier may be associated with a first cell, such as a PCell, or some other type of cell, in some examples. The UE 115-b may transmit the message via a transmission occasion, which may be a set of time and frequency resources allocated for the message transmission. The transmission occasion may be scheduled or allocated by an uplink grant received from the network entity 105-b (e.g., a DCI received via a PDCCH), as described with reference to FIG. 3. Additionally, or alternatively, the transmission occasion may be scheduled by a configured grant or some other configuration of periodic or semi-periodic resources allocated for transmissions by the UE 115-b, as described with reference to FIGS. 3 and 4.

At 520, in some examples, the UE 115-b may receive an uplink grant from the network entity 105-b. The uplink grant may indicate a failure of the message transmitted on the first component carrier and may indicate a second set of time and frequency resources for a retransmission of the message by the UE 115-b. In some examples, the network entity 105-b may transmit the uplink grant and schedule a retransmission of the message on a second component carrier different than the first component carrier based on an availability of resources for retransmitting the message, based on the capability of the UE 115-b to support cross-carrier HARQ retransmissions, and based on the one or more conditions associated with the communications by the UE 115-b satisfying a threshold condition for cross-carrier HARQ retransmissions. For example, if each of the above conditions and thresholds are satisfied, the network entity 105-b may schedule a retransmission of the message on a different (the second) component carrier. If any one or more of the conditions are not satisfied, the network entity 105-b may schedule the retransmission on a same (the first) component carrier.

At 525, the UE 115-b may retransmit the message to the network entity 105-b on the second component carrier different than the first component carrier based on conditions for cross-carrier retransmissions being satisfied. The conditions for cross-carrier retransmissions may include an availability of resources for retransmitting the message, the capability of the UE 115-b to support cross-carrier HARQ retransmissions, and the one or more conditions associated with the communications by the UE 115-b satisfying a threshold condition for cross-carrier HARQ retransmissions. In some examples, the UE 115-b may retransmit the message on the second component carrier based on the uplink grant received at 520. Additionally, or alternatively, the UE 115-b may receive a control message, such as an RRC message, or some other type of control message, that allocates multiple configured grant resources for transmissions and retransmissions by the UE 115-b, as described with reference to FIGS. 3 and 4. In such cases, the UE 115-b may autonomously determine to retransmit the message on the second component carrier based on an available set of configured grant resources and the conditions for cross-carrier retransmissions being satisfied. In some other examples, the network entity 105-b may transmit a control message that indicates a semi-static switching pattern for initial transmissions and retransmissions of an uplink message. The UE 115-b may autonomously determine to retransmit the message on the second component carrier based on the semi-static switching pattern and the one or more conditions being satisfied.

The threshold condition(s) for cross-carrier HARQ retransmissions may include a threshold uplink delay budget, a retransmission preparation time period threshold, a processing time period threshold, a threshold HARQ buffer status, a threshold quantity of loaded cycles at the UE 115-b, a threshold quantity of loaded processors at the UE 115-b, one or more other threshold conditions, or any combination thereof. The UE 115-b may indicate the conditions at the UE 115-b to the network entity 105-b via the capability message, via the assistance information, or via one or more other uplink messages. The network entity 105-b, the UE 115-b, or both may compare the conditions to the threshold conditions to determine whether the threshold conditions are satisfied.

The techniques described herein may thereby provide for a UE 115-b to perform cross-carrier HARQ retransmissions when one or more conditions are satisfied, and to perform retransmissions on a same carrier otherwise. By utilizing the defined conditions for cross-carrier HARQ retransmissions, the UE 115-b may support some scenarios in which reduced latency retransmissions are beneficial, while balancing reduced complexity and power consumption and improved reliability overall.

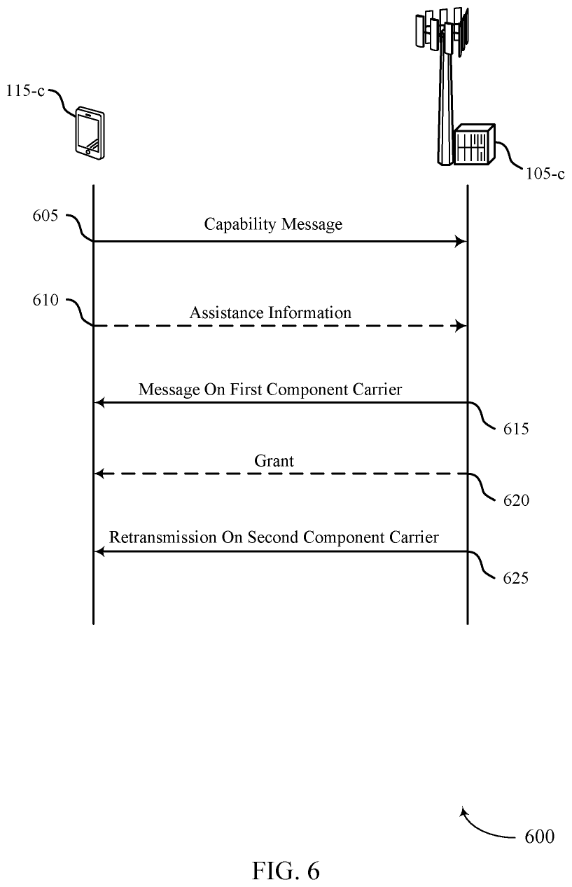

FIG. 6 illustrates an example of a process flow 600 that supports conditional HARQ retransmission across carriers in accordance with one or more aspects of the present disclosure. The process flow 600 may implement or be implemented by aspects of the wireless communications systems 100 and 200 and the HARQ transmission timelines 300 and 400, as described with reference to FIGS. 1-4. For example, the process flow 600 illustrates communications between a UE 115-c and a network entity 105-c, which may represent examples of a UE 115 and a network entity 105 as described with reference to FIGS. 1-5. In this example, the network entity 105-c may retransmit a message to the UE 115-c on a different component carrier than the initial transmission of the message based on a capability of the UE 115-c and one or more conditions associated with communications by the devices.

In the following description of the process flow 600, the operations between the UE 115-c and the network entity 105-c may be performed in different orders or at different times. Some operations may also be left out of the process flow 600, or other operations may be added. Although the UE 115-c and the network entity 105-c are shown performing the operations of the process flow 600, some aspects of some operations may also be performed by one or more other wireless devices.

At 605, the UE 115-c may transmit a capability message that indicates a capability of the UE 115-c to support cross-carrier HARQ retransmissions. In this example, the UE 115-c may support retransmissions of messages on different component carriers. The capability message may represent an example of a capability message 230, as described with reference to FIG. 2, and the capability message described with reference to FIG. 5. In some examples, the capability message may convey an indication of a time period associated with preparing a retransmission of a message on a different component carrier, or an indication of a processing time associated with retransmissions on a different component carrier, or both.

At 610, in some examples, the UE 115-c may transmit assistance information to the network entity 105-c. The assistance information may indicate one or more parameters associated with communications by the UE 115-c (e.g., communications between the UE 115-c and the network entity 105-c, or between the UE 115-c and one or more other devices). The one or more parameters may include, for example, a processing time associated with retransmissions by the UE 115-c, a status associated with a HARQ buffer at the UE 115-c, a quantity of cycles loaded at the UE 115-c, a quantity of processors loaded at the UE 115-c, or any combination thereof. The assistance information may be transmitted via an RRC message, via UCI, via a MAC-CE, or any combination thereof. In some examples, the parameters or criteria may change relatively quickly. The UCI or MAC-CE may be quicker than the RRC message, which may reduce latency associated with informing the network entity 105-c of the conditions at the UE 115-c.

At 615, the network entity 105-c may transmit a message on a first component carrier to the UE 115-c. The message may be a downlink message. The first component carrier may be associated with a first cell, such as a PCell, or some other type of cell, in some examples. The network entity 105-c may transmit the message via a transmission occasion, which may be a set of time and frequency resources allocated for the message transmission. The transmission occasion may be scheduled or allocated by a dynamic grant transmitted to the UE 115-c from the network entity 105-c (e.g., a DCI received via a PDCCH), as described with reference to FIG. 3. Additionally, or alternatively, the transmission occasion may be scheduled by control signaling indicating some other configuration of periodic or semi-periodic resources allocated for transmissions by the network entity 105-c, as described with reference to FIGS. 3 and 4.

In some examples, the UE 115-c may transmit a feedback message to the network entity 105-c in response to the message on the first component carrier. For example, the UE 115-c may monitor for, but may not receive the message, or the UE 115-c may fail to accurately receive or decode the message. In such cases, the UE 115-c may transmit a NACK that indicates a failure of the message. The NACK may implicitly indicate a request for a retransmission of the message.

At 620, in some examples, the network entity 105-c may transmit a grant to the UE 115-c (e.g., a dynamic grant). The dynamic grant may indicate a second set of time and frequency resources for a retransmission of the message by the network entity 105-c. In some examples, the network entity 105-c may transmit the dynamic grant and schedule a retransmission of the message on a second component carrier different than the first component carrier based on an availability of resources for retransmitting the message, based on the capability of the UE 115-c to support cross-carrier HARQ retransmissions, and based on the one or more conditions associated with the communications by the UE 115-c satisfying a threshold condition for cross-carrier HARQ retransmissions. For example, if each of the above conditions and thresholds are satisfied, the network entity 105-c may schedule a retransmission of the message on a different (the second) component carrier. If any one or more of the conditions are not satisfied, the network entity 105-c may schedule the retransmission on a same (the first) component carrier. In some examples, the network entity 105-c may transmit the grant based on or in response to the feedback from the UE 115-c indicating a NACK.

At 625, the network entity 105-c may retransmit the message to the UE 115-c on the second component carrier different than the first component carrier based on conditions for cross-carrier retransmissions being satisfied. The conditions for cross-carrier retransmissions may include an availability of resources for retransmitting the message, the capability of the UE 115-c to support cross-carrier HARQ retransmissions, and the one or more conditions associated with the communications by the UE 115-c satisfying a threshold condition for cross-carrier HARQ retransmissions. In some examples, the network entity 105-c may retransmit the message on the second component carrier via a transmission occasion that is based on or allocated by the dynamic grant transmitted at 520. Additionally, or alternatively, the network entity 105-c may transmit (e.g., before transmitting the message on the first component carrier) a control message, such as an RRC message, or some other type of control message to the UE 115-c, that indicates a semi-static switching pattern for initial transmissions and retransmissions of downlink messages, as described with reference to FIGS. 3 and 4. In such cases, the UE 115-c may autonomously determine to monitor for the retransmission of the message on the second component carrier based on the conditions for cross-carrier retransmissions being satisfied and the semi-static switching pattern.

The threshold condition(s) for cross-carrier HARQ retransmissions may include a threshold uplink delay budget, a retransmission preparation time period threshold, a processing time period threshold, a threshold HARQ buffer status, a threshold quantity of loaded cycles at the UE 115-c, a threshold quantity of loaded processors at the UE 115-c, one or more other threshold conditions, or any combination thereof. The UE 115-c may indicate the conditions at the UE 115-c to the network entity 105-c via the capability message, via the assistance information, or via one or more other uplink messages. The network entity 105-c, the UE 115-c, or both may compare the conditions to the threshold conditions to determine whether the threshold conditions are satisfied.

The techniques described herein may thereby provide for a network entity 105-c to perform cross-carrier HARQ retransmissions when one or more conditions are satisfied, and to perform retransmissions on a same carrier otherwise. By utilizing the defined conditions for cross-carrier HARQ retransmissions, the network entity 105-c and the UE 115-c may support some scenarios in which reduced latency retransmissions are beneficial, while balancing reduced complexity and power consumption and improved reliability overall.

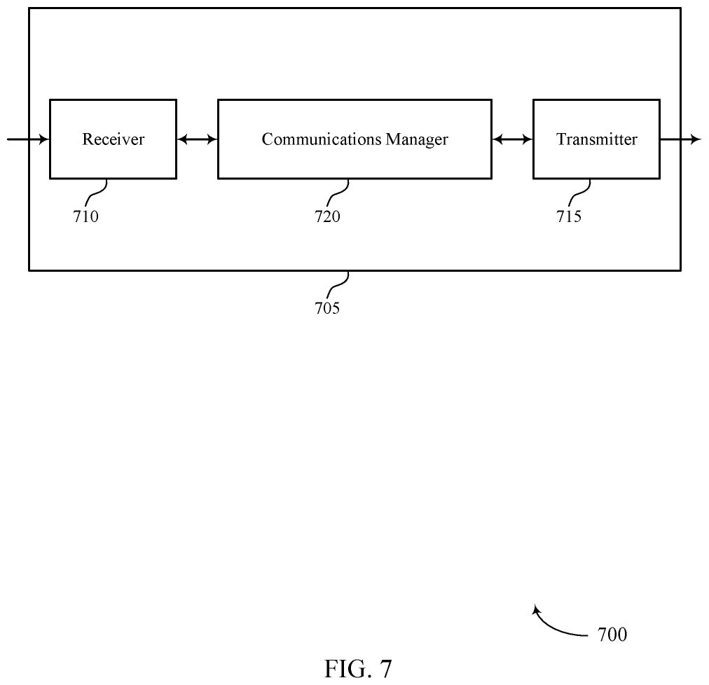

FIG. 7 illustrates a block diagram 700 of a device 705 that supports conditional HARQ retransmission across carriers in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to conditional HARQ retransmission across carriers). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to conditional HARQ retransmission across carriers). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of conditional HARQ retransmission across carriers as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. For example, the communications manager 720 may be configured as or otherwise support a means for transmitting a capability message that indicates a capability of the UE to support cross-carrier HARQ retransmissions. The communications manager 720 may be configured as or otherwise support a means for transmitting a message on a first component carrier. The communications manager 720 may be configured as or otherwise support a means for retransmitting the message on a second component carrier different than the first component carrier based on an availability of resources for retransmitting the message, the capability of the UE to support the cross-carrier HARQ retransmissions, and one or more conditions associated with communications by the UE satisfying a threshold condition for the cross-carrier HARQ retransmissions.

Additionally, or alternatively, the communications manager 720 may support wireless communication at a UE in accordance with examples as disclosed herein. For example, the communications manager 720 may be configured as or otherwise support a means for transmitting a capability message that indicates a capability of the UE to support cross-carrier HARQ retransmissions. The communications manager 720 may be configured as or otherwise support a means for receiving a message on a first component carrier. The communications manager 720 may be configured as or otherwise support a means for receiving a retransmission of the message on a second component carrier different than the first component carrier, where receiving the retransmission of the message on the second component carrier is based on the capability of the UE to support the cross-carrier HARQ retransmissions and one or more conditions associated with communications by the UE satisfying a threshold condition for the cross-carrier HARQ retransmissions.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reduced processing, reduced power consumption, and more efficient utilization of communication resources.

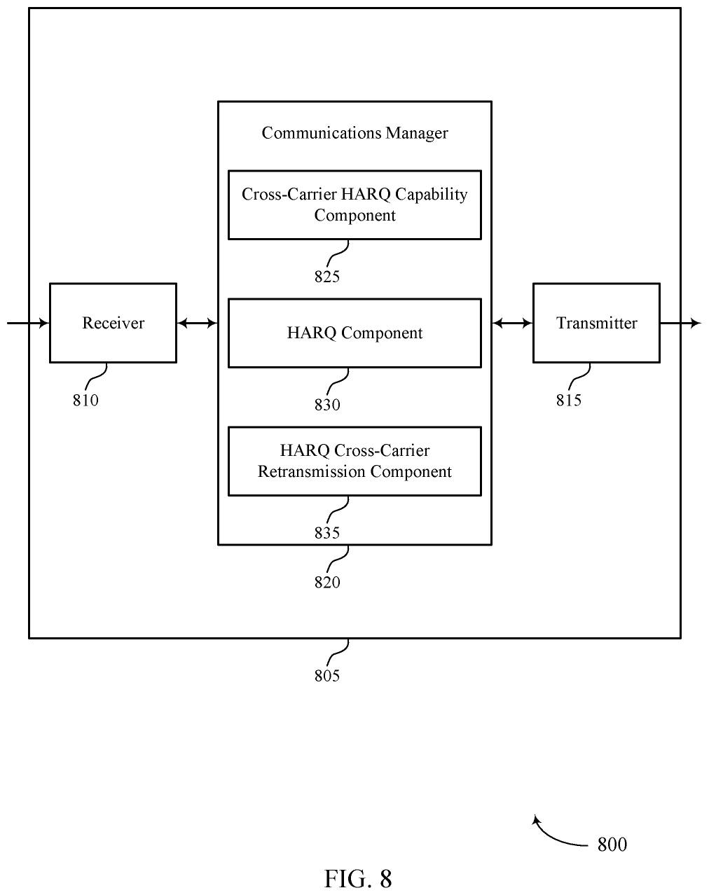

FIG. 8 illustrates a block diagram 800 of a device 805 that supports conditional HARQ retransmission across carriers in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to conditional HARQ retransmission across carriers). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to conditional HARQ retransmission across carriers). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of conditional HARQ retransmission across carriers as described herein. For example, the communications manager 820 may include a cross-carrier HARQ capability component 825, an HARQ component 830, an HARQ cross-carrier retransmission component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. The cross-carrier HARQ capability component 825 may be configured as or otherwise support a means for transmitting a capability message that indicates a capability of the UE to support cross-carrier HARQ retransmissions. The HARQ component 830 may be configured as or otherwise support a means for transmitting a message on a first component carrier. The HARQ cross-carrier retransmission component 835 may be configured as or otherwise support a means for retransmitting the message on a second component carrier different than the first component carrier based on an availability of resources for retransmitting the message, the capability of the UE to support the cross-carrier HARQ retransmissions, and one or more conditions associated with communications by the UE satisfying a threshold condition for the cross-carrier HARQ retransmissions.

Additionally, or alternatively, the communications manager 820 may support wireless communication at a UE in accordance with examples as disclosed herein. The cross-carrier HARQ capability component 825 may be configured as or otherwise support a means for transmitting a capability message that indicates a capability of the UE to support cross-carrier HARQ retransmissions. The HARQ component 830 may be configured as or otherwise support a means for receiving a message on a first component carrier. The HARQ cross-carrier retransmission component 835 may be configured as or otherwise support a means for receiving a retransmission of the message on a second component carrier different than the first component carrier, where receiving the retransmission of the message on the second component carrier is based on the capability of the UE to support the cross-carrier HARQ retransmissions and one or more conditions associated with communications by the UE satisfying a threshold condition for the cross-carrier HARQ retransmissions.

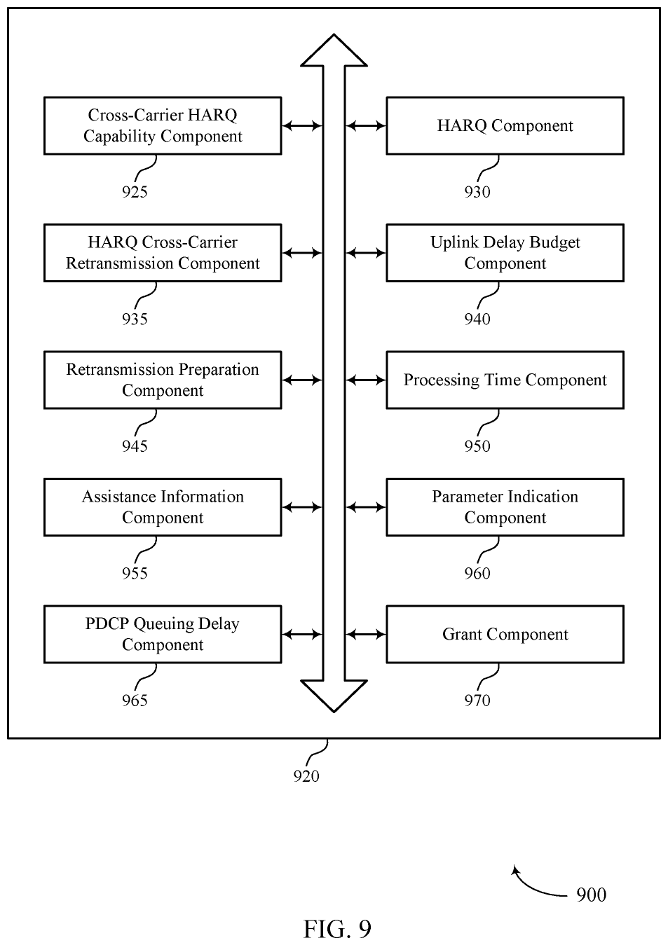

FIG. 9 illustrates a block diagram 900 of a communications manager 920 that supports conditional HARQ retransmission across carriers in accordance with one or more aspects of the present disclosure. The communications manager 920 may be an example of aspects of a communications manager 720, a communications manager 820, or both, as described herein. The communications manager 920, or various components thereof, may be an example of means for performing various aspects of conditional HARQ retransmission across carriers as described herein. For example, the communications manager 920 may include a cross-carrier HARQ capability component 925, an HARQ component 930, an HARQ cross-carrier retransmission component 935, an uplink delay budget component 940, a retransmission preparation component 945, a processing time component 950, an assistance information component 955, a parameter indication component 960, a PDCP queuing delay component 965, a grant component 970, or any combination thereof. Each of these components may communicate, directly or indirectly, with one another (e.g., via one or more buses).

The communications manager 920 may support wireless communication at a UE in accordance with examples as disclosed herein. The cross-carrier HARQ capability component 925 may be configured as or otherwise support a means for transmitting a capability message that indicates a capability of the UE to support cross-carrier HARQ retransmissions. The HARQ component 930 may be configured as or otherwise support a means for transmitting a message on a first component carrier. The HARQ cross-carrier retransmission component 935 may be configured as or otherwise support a means for retransmitting the message on a second component carrier different than the first component carrier based on an availability of resources for retransmitting the message, the capability of the UE to support the cross-carrier HARQ retransmissions, and one or more conditions associated with communications by the UE satisfying a threshold condition for the cross-carrier HARQ retransmissions.

In some examples, the uplink delay budget component 940 may be configured as or otherwise support a means for receiving a control message indicating a threshold uplink delay budget. In some examples, the uplink delay budget component 940 may be configured as or otherwise support a means for transmitting a second message indicating whether a remaining uplink delay budget of the UE satisfies the threshold uplink delay budget based on comparing the remaining uplink delay budget with the threshold uplink delay budget. In some examples, retransmitting the message on the second component carrier is based on the second message indicating that the remaining uplink delay budget satisfies the threshold uplink delay budget.

In some examples, the retransmission preparation component 945 may be configured as or otherwise support a means for transmitting, via the capability message, an indication of a time period associated with preparing a retransmission of the message on the second component carrier, where retransmitting the message is based on the time period being less than a threshold time period.

In some examples, the processing time component 950 may be configured as or otherwise support a means for transmitting, via the capability message, an indication of a processing time associated with retransmissions by the UE.

In some examples, the assistance information component 955 may be configured as or otherwise support a means for transmitting assistance information that indicates one or more parameters associated with the communications by the UE, where the one or more conditions are based on the one or more parameters indicated via the assistance information. In some examples, the one or more parameters include a processing time associated with retransmissions by the UE, a status associated with a HARQ buffer at the UE, a quantity of cycles loaded at the UE, a quantity of processors loaded at the UE, or any combination thereof.

In some examples, to support transmitting the assistance information, the assistance information component 955 may be configured as or otherwise support a means for transmitting an RRC message that indicates the one or more parameters associated with the communications by the UE.

In some examples, the parameter indication component 960 may be configured as or otherwise support a means for transmitting a UCI message or a MAC-CE that indicates one or more parameters associated with the communications by the UE, where the one or more conditions are based on the one or more parameters indicated via the UCI message or the MAC-CE.

In some examples, the assistance information component 955 may be configured as or otherwise support a means for transmitting assistance information including a request to enable the cross-carrier HARQ retransmissions based on a status associated with one or more processors of the UE satisfying a threshold processor status, where retransmitting the message on the second component carrier is based on the request.

In some examples, the PDCP queuing delay component 965 may be configured as or otherwise support a means for comparing an uplink PDCP queuing delay of the UE to a threshold PDCP queuing delay. In some examples, the PDCP queuing delay component 965 may be configured as or otherwise support a means for transmitting uplink control information indicating that the uplink PDCP queuing delay satisfies the threshold PDCP queuing delay based on the comparing, the uplink control information being multiplexed with the message on the first component carrier. In some examples, the grant component 970 may be configured as or otherwise support a means for receiving, on the first component carrier, a grant that indicates a transmission occasion for retransmitting the message on the second component carrier, where retransmitting the message is based on the grant and the uplink PDCP queuing delay satisfying the threshold PDCP queuing delay.

In some examples, the grant component 970 may be configured as or otherwise support a means for receiving, based on the capability of the UE and the one or more conditions satisfying the threshold condition, a grant that indicates a transmission occasion for retransmitting the message on the second component carrier, where the message is retransmitted via the transmission occasion on the second component carrier based on the grant.

In some examples, the grant component 970 may be configured as or otherwise support a means for receiving a control message that configures a set of configured grant resources for HARQ retransmissions on the first component carrier and the second component carrier, the set of configured grant resources including at least a first resource on the first component carrier for transmission of the message and a second resource on the second component carrier for at least one retransmission of the message. In some examples, the HARQ cross-carrier retransmission component 935 may be configured as or otherwise support a means for retransmitting the message via the second resource of the set of configured grant resources based on the capability of the UE and the one or more conditions satisfying the threshold condition.

In some examples, the HARQ cross-carrier retransmission component 935 may be configured as or otherwise support a means for receiving a control message that configures a semi-static switching pattern for switching between the first component carrier and the second component carrier for at least one retransmission, where retransmitting the message on the second component carrier is based on the semi-static switching pattern.

In some examples, the HARQ cross-carrier retransmission component 935 may be configured as or otherwise support a means for receiving, based on transmitting the message, DCI that indicates a request for a retransmission of the message, where retransmitting the message is based on the request, and where a carrier indication field in the DCI includes information for the UE that is different than a carrier indication based on the semi-static switching pattern.

In some examples, the one or more conditions include a PER, an RSRP, or both measured by the UE.

Additionally, or alternatively, the communications manager 920 may support wireless communication at a UE in accordance with examples as disclosed herein. In some examples, the cross-carrier HARQ capability component 925 may be configured as or otherwise support a means for transmitting a capability message that indicates a capability of the UE to support cross-carrier HARQ retransmissions. In some examples, the HARQ component 930 may be configured as or otherwise support a means for receiving a message on a first component carrier. In some examples, the HARQ cross-carrier retransmission component 935 may be configured as or otherwise support a means for receiving a retransmission of the message on a second component carrier different than the first component carrier, where receiving the retransmission of the message on the second component carrier is based on the capability of the UE to support the cross-carrier HARQ retransmissions and one or more conditions associated with communications by the UE satisfying a threshold condition for the cross-carrier HARQ retransmissions.

In some examples, the processing time component 950 may be configured as or otherwise support a means for transmitting, via the capability message, an indication of a processing time associated with retransmissions by the UE.

In some examples, the assistance information component 955 may be configured as or otherwise support a means for transmitting assistance information that indicates one or more parameters associated with communications by the UE, where the one or more conditions are based on the one or more parameters indicated via the assistance information. In some examples, the one or more parameters include a processing time associated with retransmissions by the UE, a status associated with a HARQ buffer at the UE, a quantity of cycles loaded at the UE, a quantity of processors loaded at the UE, or any combination thereof.

In some examples, to support transmitting the assistance information, the assistance information component 955 may be configured as or otherwise support a means for transmitting an RRC message that indicates the one or more parameters associated with the communications by the UE.

In some examples, the parameter indication component 960 may be configured as or otherwise support a means for transmitting a UCI message or a MAC-CE that indicates one or more parameters associated with the communications by the UE, where the one or more conditions are based on the one or more parameters indicated via the UCI message or the MAC-CE.

In some examples, the assistance information component 955 may be configured as or otherwise support a means for transmitting assistance information including a request to enable the cross-carrier HARQ retransmissions based on a status associated with one or more processors of the UE satisfying a threshold processor status, where receiving the retransmission of the message on the second component carrier is based on the request.

In some examples, the grant component 970 may be configured as or otherwise support a means for receiving a grant that schedules a transmission occasion on the second component carrier for the retransmission of the message based on the one or more conditions satisfying the threshold condition, where the retransmission of the message is received via the transmission occasion on the second component carrier based on the grant.

In some examples, the HARQ cross-carrier retransmission component 935 may be configured as or otherwise support a means for receiving a control message that configures a semi-static switching pattern for switching between the first component carrier and the second component carrier for at least one retransmission, where receiving the retransmission of the message on the second component carrier is based on the semi-static switching pattern.

In some examples, the HARQ cross-carrier retransmission component 935 may be configured as or otherwise support a means for receiving, based on the message, DCI that indicates the retransmission of the message, where receiving the retransmission of the message is based on the DCI, and where a carrier indication field in the DCI includes information for the UE that is different than a carrier indication based on the semi-static switching pattern.

In some examples, the one or more conditions include a packet error rate, an RSRP, or both measured by the UE.

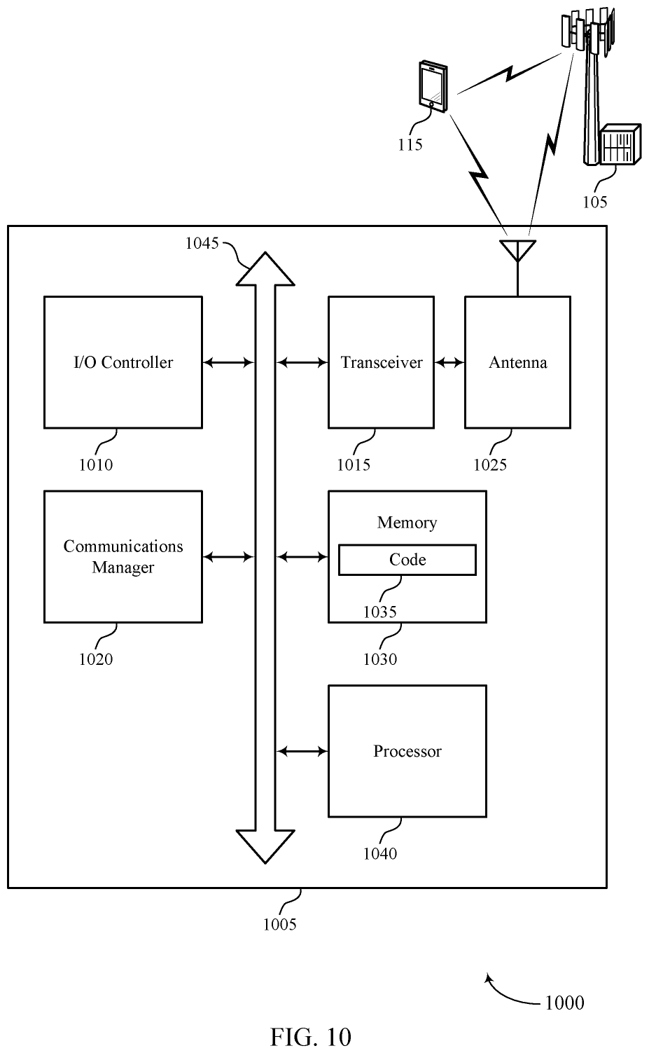

FIG. 10 illustrates a diagram of a system 1000 including a device 1005 that supports conditional HARQ retransmission across carriers in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting conditional HARQ retransmission across carriers). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for transmitting a capability message that indicates a capability of the UE to support cross-carrier HARQ retransmissions. The communications manager 1020 may be configured as or otherwise support a means for transmitting a message on a first component carrier. The communications manager 1020 may be configured as or otherwise support a means for retransmitting the message on a second component carrier different than the first component carrier based on an availability of resources for retransmitting the message, the capability of the UE to support the cross-carrier HARQ retransmissions, and one or more conditions associated with communications by the UE satisfying a threshold condition for the cross-carrier HARQ retransmissions.

Additionally, or alternatively, the communications manager 1020 may support wireless communication at a UE in accordance with examples as disclosed herein. For example, the communications manager 1020 may be configured as or otherwise support a means for transmitting a capability message that indicates a capability of the UE to support cross-carrier HARQ retransmissions. The communications manager 1020 may be configured as or otherwise support a means for receiving a message on a first component carrier. The communications manager 1020 may be configured as or otherwise support a means for receiving a retransmission of the message on a second component carrier different than the first component carrier, where receiving the retransmission of the message on the second component carrier is based on the capability of the UE to support the cross-carrier HARQ retransmissions and one or more conditions associated with communications by the UE satisfying a threshold condition for the cross-carrier HARQ retransmissions.

By including or configuring the communications manager 1020 in accordance with examples as described herein, the device 1005 may support techniques for improved communication reliability, reduced latency, reduced power consumption, more efficient utilization of communication resources, and improved coordination between devices.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of conditional HARQ retransmission across carriers as described herein, or the processor 1040 and the memory 1030 may be otherwise configured to perform or support such operations.

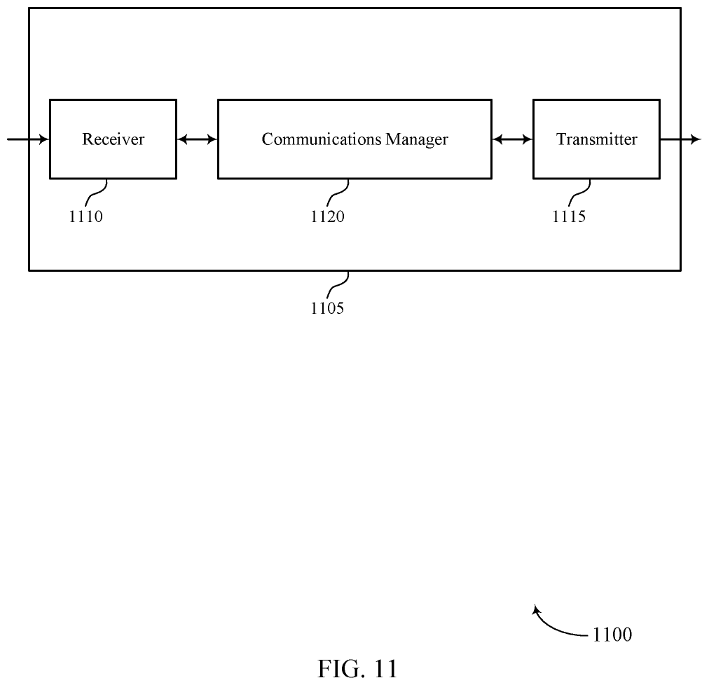

FIG. 11 illustrates a block diagram 1100 of a device 1105 that supports conditional HARQ retransmission across carriers in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of conditional HARQ retransmission across carriers as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. For example, the communications manager 1120 may be configured as or otherwise support a means for receiving a capability message that indicates a capability of a UE to support cross-carrier HARQ retransmissions. The communications manager 1120 may be configured as or otherwise support a means for receiving a message on a first component carrier. The communications manager 1120 may be configured as or otherwise support a means for receiving a retransmission of the message on a second component carrier different than the first component carrier based on an availability of resources for retransmitting the message, the capability of the UE to support the cross-carrier HARQ retransmissions, and one or more conditions associated with communications between the network entity and the UE satisfying a threshold condition for the cross-carrier HARQ retransmissions.

Additionally, or alternatively, the communications manager 1120 may support wireless communication at a network entity in accordance with examples as disclosed herein. For example, the communications manager 1120 may be configured as or otherwise support a means for receiving a capability message that indicates a capability of a UE to support cross-carrier HARQ retransmissions. The communications manager 1120 may be configured as or otherwise support a means for transmitting a message on a first component carrier. The communications manager 1120 may be configured as or otherwise support a means for retransmitting the message on a second component carrier different than the first component carrier, where retransmitting the message on the second component carrier is based on the capability of the UE to support the cross-carrier HARQ retransmissions and one or more conditions associated with communications between the network entity and the UE satisfying a threshold condition for the cross-carrier HARQ retransmissions.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for reduced processing, reduced power consumption, and more efficient utilization of communication resources.

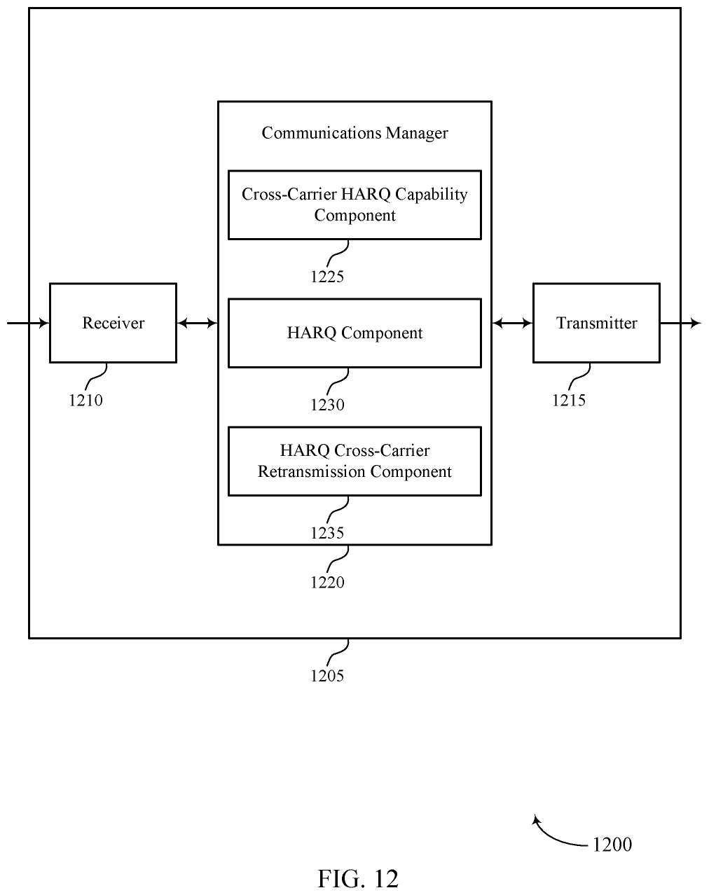

FIG. 12 illustrates a block diagram 1200 of a device 1205 that supports conditional HARQ retransmission across carriers in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of conditional HARQ retransmission across carriers as described herein. For example, the communications manager 1220 may include a cross-carrier HARQ capability component 1225, an HARQ component 1230, an HARQ cross-carrier retransmission component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. The cross-carrier HARQ capability component 1225 may be configured as or otherwise support a means for receiving a capability message that indicates a capability of a UE to support cross-carrier HARQ retransmissions. The HARQ component 1230 may be configured as or otherwise support a means for receiving a message on a first component carrier. The HARQ cross-carrier retransmission component 1235 may be configured as or otherwise support a means for receiving a retransmission of the message on a second component carrier different than the first component carrier based on an availability of resources for retransmitting the message, the capability of the UE to support the cross-carrier HARQ retransmissions, and one or more conditions associated with communications between the network entity and the UE satisfying a threshold condition for the cross-carrier HARQ retransmissions.

Additionally, or alternatively, the communications manager 1220 may support wireless communication at a network entity in accordance with examples as disclosed herein. The cross-carrier HARQ capability component 1225 may be configured as or otherwise support a means for receiving a capability message that indicates a capability of a UE to support cross-carrier HARQ retransmissions. The HARQ component 1230 may be configured as or otherwise support a means for transmitting a message on a first component carrier. The HARQ cross-carrier retransmission component 1235 may be configured as or otherwise support a means for retransmitting the message on a second component carrier different than the first component carrier, where retransmitting the message on the second component carrier is based on the capability of the UE to support the cross-carrier HARQ retransmissions and one or more conditions associated with communications between the network entity and the UE satisfying a threshold condition for the cross-carrier HARQ retransmissions.

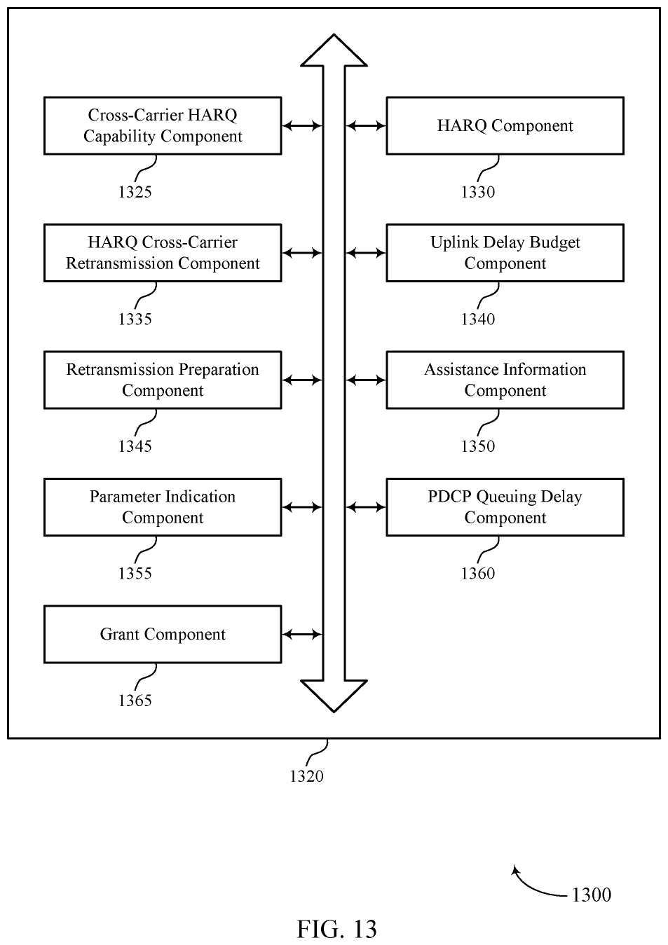

FIG. 13 illustrates a block diagram 1300 of a communications manager 1320 that supports conditional HARQ retransmission across carriers in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of conditional HARQ retransmission across carriers as described herein. For example, the communications manager 1320 may include a cross-carrier HARQ capability component 1325, an HARQ component 1330, an HARQ cross-carrier retransmission component 1335, an uplink delay budget component 1340, a retransmission preparation component 1345, an assistance information component 1350, a parameter indication component 1355, a PDCP queuing delay component 1360, a grant component 1365, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples as disclosed herein. The cross-carrier HARQ capability component 1325 may be configured as or otherwise support a means for receiving a capability message that indicates a capability of a UE to support cross-carrier HARQ retransmissions. The HARQ component 1330 may be configured as or otherwise support a means for receiving a message on a first component carrier. The HARQ cross-carrier retransmission component 1335 may be configured as or otherwise support a means for receiving a retransmission of the message on a second component carrier different than the first component carrier based on an availability of resources for retransmitting the message, the capability of the UE to support the cross-carrier HARQ retransmissions, and one or more conditions associated with communications between the network entity and the UE satisfying a threshold condition for the cross-carrier HARQ retransmissions.

In some examples, the uplink delay budget component 1340 may be configured as or otherwise support a means for transmitting a control message indicating a threshold uplink delay budget. In some examples, the uplink delay budget component 1340 may be configured as or otherwise support a means for receiving a second message indicating whether a remaining uplink delay budget of the UE satisfies the threshold uplink delay budget, where receiving the retransmission of the message on the second component carrier is based on the second message indicating that the remaining uplink delay budget satisfies the threshold uplink delay budget.

In some examples, the retransmission preparation component 1345 may be configured as or otherwise support a means for receiving, via the capability message, an indication of a time period associated with preparation, by the UE, of a retransmission of the message on the second component carrier, the time period based on a processing time associated with retransmissions by the UE, where receiving the retransmission of the message is based on the time period being less than a threshold time period.

In some examples, the assistance information component 1350 may be configured as or otherwise support a means for receiving assistance information that indicates one or more parameters associated with the communications by the UE, where the one or more conditions are based on the one or more parameters indicated via the assistance information. In some examples, the one or more parameters include a processing time associated with retransmissions by the UE, a status associated with a HARQ buffer at the UE, a quantity of cycles loaded at the UE, a quantity of processors loaded at the UE, or any combination thereof.

In some examples, to support receiving the assistance information, the assistance information component 1350 may be configured as or otherwise support a means for receiving an RRC message that indicates the one or more parameters associated with the communications by the UE.

In some examples, the parameter indication component 1355 may be configured as or otherwise support a means for receiving a UCI message or a MAC-CE that indicates one or more parameters associated with the communications by the UE, where the one or more conditions are based on the one or more parameters indicated via the UCI message or the MAC-CE.

In some examples, the assistance information component 1350 may be configured as or otherwise support a means for receiving assistance information including a request to enable the cross-carrier HARQ retransmissions based on a status associated with one or more processors of the UE satisfying a threshold processor status, where receiving the retransmission of the message on the second component carrier is based on the request.

In some examples, the PDCP queuing delay component 1360 may be configured as or otherwise support a means for receiving uplink control information indicating that an uplink PDCP queuing delay of the UE satisfies a threshold PDCP queuing delay, the uplink control information being multiplexed with the message on the first component carrier. In some examples, the PDCP queuing delay component 1360 may be configured as or otherwise support a means for transmitting, on the first component carrier, a grant that indicates a transmission occasion for the retransmission of the message on the second component carrier, where the retransmission of the message is received based on the grant and the uplink PDCP queuing delay satisfying the threshold PDCP queuing delay.

In some examples, the grant component 1365 may be configured as or otherwise support a means for transmitting, based on the capability of the UE and the one or more conditions satisfying the threshold condition, a grant that indicates a transmission occasion for the retransmission of the message on the second component carrier, where the retransmission of the message is received via the transmission occasion on the second component carrier based on the grant.

In some examples, the grant component 1365 may be configured as or otherwise support a means for transmitting a control message that configures a set of configured grant resources for HARQ retransmissions on the first component carrier and the second component carrier, the set of configured grant resources including at least a first resource on the first component carrier for transmission of the message and a second resource on the second component carrier for at least one retransmission of the message, where the retransmission of the message is received via the second resource of the set of configured grant resources based on the capability of the UE and the one or more conditions satisfying the threshold condition.

In some examples, the HARQ cross-carrier retransmission component 1335 may be configured as or otherwise support a means for transmitting a control message that configures a semi-static switching pattern for switching between the first component carrier and the second component carrier for at least one retransmission, where receiving the retransmission of the message on the second component carrier is based on the semi-static switching pattern.

In some examples, the HARQ cross-carrier retransmission component 1335 may be configured as or otherwise support a means for transmitting, based on receiving the message, DCI that indicates a request for a retransmission of the message, where receiving the retransmission of the message is based on the request, and where a carrier indication field in the DCI includes information for the UE that is different than a carrier indication based on the semi-static switching pattern.

In some examples, the one or more conditions include a packet error rate, an RSRP, or both measured by the UE.

Additionally, or alternatively, the communications manager 1320 may support wireless communication at a network entity in accordance with examples as disclosed herein. In some examples, the cross-carrier HARQ capability component 1325 may be configured as or otherwise support a means for receiving a capability message that indicates a capability of a UE to support cross-carrier HARQ retransmissions. In some examples, the HARQ component 1330 may be configured as or otherwise support a means for transmitting a message on a first component carrier. In some examples, the HARQ cross-carrier retransmission component 1335 may be configured as or otherwise support a means for retransmitting the message on a second component carrier different than the first component carrier, where retransmitting the message on the second component carrier is based on the capability of the UE to support the cross-carrier HARQ retransmissions and one or more conditions associated with communications between the network entity and the UE satisfying a threshold condition for the cross-carrier HARQ retransmissions.

In some examples, the parameter indication component 1355 may be configured as or otherwise support a means for receiving, via the capability message, an indication of a processing time associated with retransmissions by the UE.

In some examples, the assistance information component 1350 may be configured as or otherwise support a means for receiving assistance information that indicates one or more parameters associated with communications by the UE, where the one or more conditions are based on the one or more parameters indicated via the assistance information. In some examples, the one or more parameters include a processing time associated with retransmissions by the UE, a status associated with a HARQ buffer at the UE, a quantity of cycles loaded at the UE, a quantity of processors loaded at the UE, or any combination thereof.

In some examples, to support receiving the assistance information, the assistance information component 1350 may be configured as or otherwise support a means for receiving an RRC message that indicates the one or more parameters associated with the communications by the UE.

In some examples, the parameter indication component 1355 may be configured as or otherwise support a means for receiving a UCI message or a MAC-CE that indicates one or more parameters associated with the communications by the UE, where the one or more conditions are based on the one or more parameters indicated via the UCI message or the MAC-CE.

In some examples, the assistance information component 1350 may be configured as or otherwise support a means for receiving assistance information including a request to enable the cross-carrier HARQ retransmissions based on a status associated with one or more processors of the UE satisfying a threshold processor status, where retransmitting the message on the second component carrier is based on the request.

In some examples, the grant component 1365 may be configured as or otherwise support a means for transmitting a grant that schedules a transmission occasion on the second component carrier for a retransmission of the message based on the one or more conditions satisfying the threshold condition, where the message is retransmitted via the transmission occasion on the second component carrier based on the grant.

In some examples, the HARQ cross-carrier retransmission component 1335 may be configured as or otherwise support a means for transmitting a control message that configures a semi-static switching pattern for switching between the first component carrier and the second component carrier for at least one retransmission, where retransmitting the message on the second component carrier is based on the semi-static switching pattern.

In some examples, the HARQ cross-carrier retransmission component 1335 may be configured as or otherwise support a means for transmitting, based on the message, DCI that indicates a retransmission of the message, where retransmitting the message is based on the DCI, and where a carrier indication field in the DCI includes information for the UE that is different than a carrier indication based on the semi-static switching pattern.

In some examples, the one or more conditions include a packet error rate, an RSRP, or both measured by the UE.

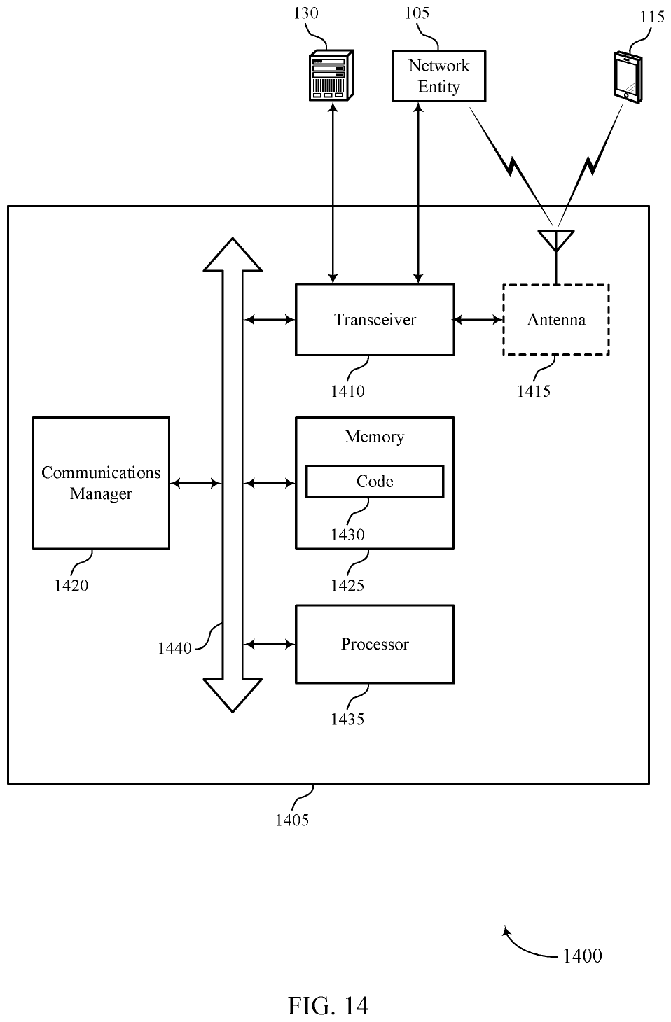

FIG. 14 illustrates a diagram of a system 1400 including a device 1405 that supports conditional HARQ retransmission across carriers in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting conditional HARQ retransmission across carriers). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network entity in accordance with examples as disclosed herein. For example, the communications manager 1420 may be configured as or otherwise support a means for receiving a capability message that indicates a capability of a UE to support cross-carrier HARQ retransmissions. The communications manager 1420 may be configured as or otherwise support a means for receiving a message on a first component carrier. The communications manager 1420 may be configured as or otherwise support a means for receiving a retransmission of the message on a second component carrier different than the first component carrier based on an availability of resources for retransmitting the message, the capability of the UE to support the cross-carrier HARQ retransmissions, and one or more conditions associated with communications between the network entity and the UE satisfying a threshold condition for the cross-carrier HARQ retransmissions.

Additionally, or alternatively, the communications manager 1420 may support wireless communication at a network entity in accordance with examples as disclosed herein. For example, the communications manager 1420 may be configured as or otherwise support a means for receiving a capability message that indicates a capability of a UE to support cross-carrier HARQ retransmissions. The communications manager 1420 may be configured as or otherwise support a means for transmitting a message on a first component carrier. The communications manager 1420 may be configured as or otherwise support a means for retransmitting the message on a second component carrier different than the first component carrier, where retransmitting the message on the second component carrier is based on the capability of the UE to support the cross-carrier HARQ retransmissions and one or more conditions associated with communications between the network entity and the UE satisfying a threshold condition for the cross-carrier HARQ retransmissions.

By including or configuring the communications manager 1420 in accordance with examples as described herein, the device 1405 may support techniques for improved communication reliability, reduced latency, reduced power consumption, more efficient utilization of communication resources, and improved coordination between devices.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of conditional HARQ retransmission across carriers as described herein, or the processor 1435 and the memory 1425 may be otherwise configured to perform or support such operations.

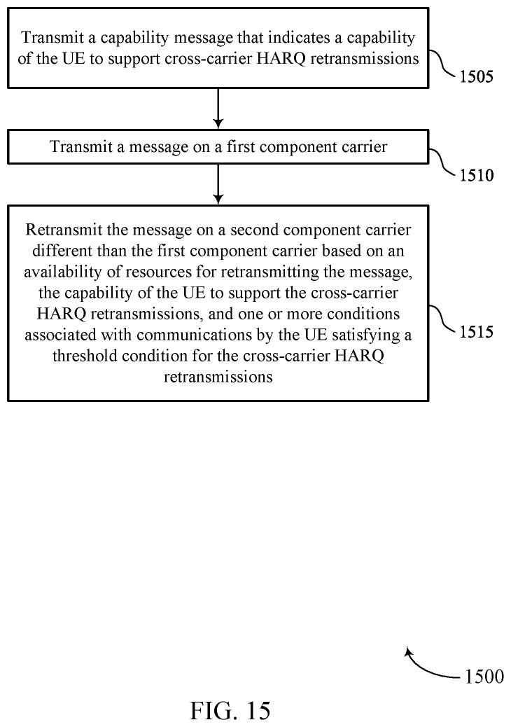

FIG. 15 illustrates a flowchart showing a method 1500 that supports conditional HARQ retransmission across carriers in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include transmitting a capability message that indicates a capability of the UE to support cross-carrier HARQ retransmissions. The operations of 1505 may be performed in accordance with examples as disclosed herein. In some examples, aspects of the operations of 1505 may be performed by a cross-carrier HARQ capability component 925 as described with reference to FIG. 9.

At 1510, the method may include transmitting a message on a first component carrier. The operations of 1510 may be performed in accordance with examples as disclosed herein. In some examples, aspects of the operations of 1510 may be performed by an HARQ component 930 as described with reference to FIG. 9.

At 1515, the method may include retransmitting the message on a second component carrier different than the first component carrier based on an availability of resources for retransmitting the message, the capability of the UE to support the cross-carrier HARQ retransmissions, and one or more conditions associated with communications by the UE satisfying a threshold condition for the cross-carrier HARQ retransmissions. The operations of 1515 may be performed in accordance with examples as disclosed herein. In some examples, aspects of the operations of 1515 may be performed by an HARQ cross-carrier retransmission component 935 as described with reference to FIG. 9.

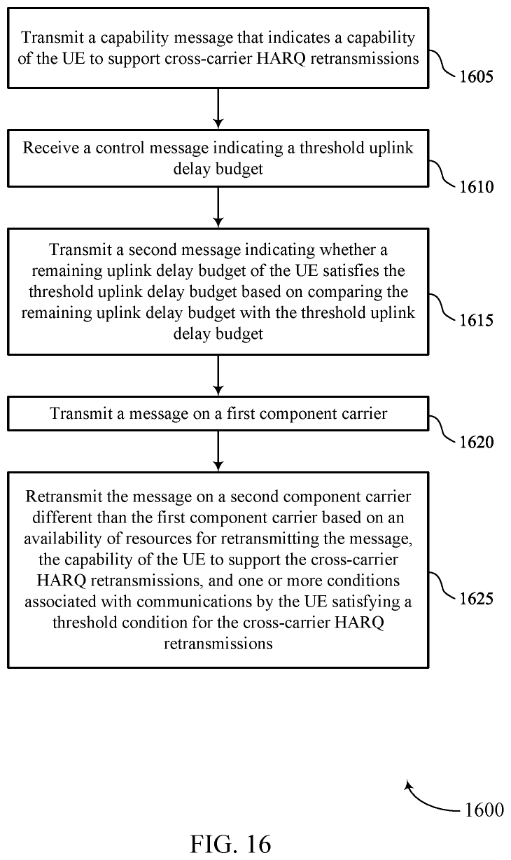

FIG. 16 illustrates a flowchart showing a method 1600 that supports conditional HARQ retransmission across carriers in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include transmitting a capability message that indicates a capability of the UE to support cross-carrier HARQ retransmissions. The operations of 1605 may be performed in accordance with examples as disclosed herein. In some examples, aspects of the operations of 1605 may be performed by a cross-carrier HARQ capability component 925 as described with reference to FIG. 9.

At 1610, the method may include receiving a control message indicating a threshold uplink delay budget. The operations of 1610 may be performed in accordance with examples as disclosed herein. In some examples, aspects of the operations of 1610 may be performed by an uplink delay budget component 940 as described with reference to FIG. 9.

At 1615, the method may include transmitting a second message indicating whether a remaining uplink delay budget of the UE satisfies the threshold uplink delay budget based on comparing the remaining uplink delay budget with the threshold uplink delay budget. The operations of 1615 may be performed in accordance with examples as disclosed herein. In some examples, aspects of the operations of 1615 may be performed by an uplink delay budget component 940 as described with reference to FIG. 9.

At 1620, the method may include transmitting a message on a first component carrier. The operations of 1620 may be performed in accordance with examples as disclosed herein. In some examples, aspects of the operations of 1620 may be performed by an HARQ component 930 as described with reference to FIG. 9.

At 1625, the method may include retransmitting the message on a second component carrier different than the first component carrier based on an availability of resources for retransmitting the message, the capability of the UE to support the cross-carrier HARQ retransmissions, and one or more conditions associated with communications by the UE satisfying a threshold condition for the cross-carrier HARQ retransmissions. The operations of 1625 may be performed in accordance with examples as disclosed herein. In some examples, aspects of the operations of 1625 may be performed by an HARQ cross-carrier retransmission component 935 as described with reference to FIG. 9.

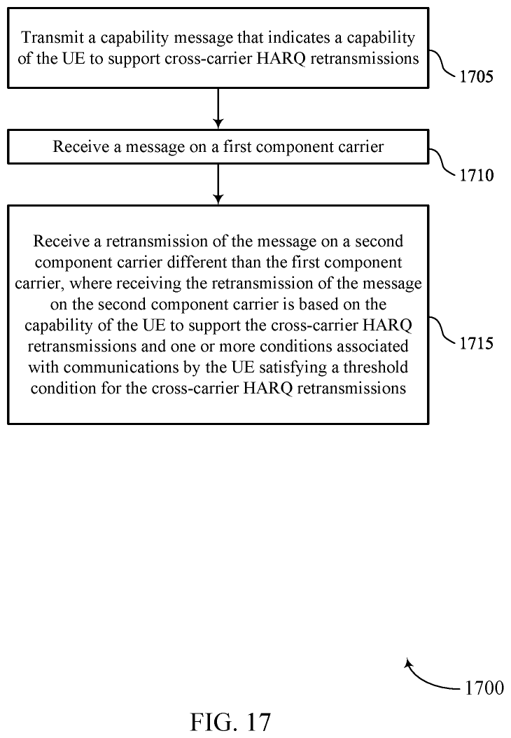

FIG. 17 illustrates a flowchart showing a method 1700 that supports conditional HARQ retransmission across carriers in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include transmitting a capability message that indicates a capability of the UE to support cross-carrier HARQ retransmissions. The operations of 1705 may be performed in accordance with examples as disclosed herein. In some examples, aspects of the operations of 1705 may be performed by a cross-carrier HARQ capability component 925 as described with reference to FIG. 9.

At 1710, the method may include receiving a message on a first component carrier. The operations of 1710 may be performed in accordance with examples as disclosed herein. In some examples, aspects of the operations of 1710 may be performed by an HARQ component 930 as described with reference to FIG. 9.

At 1715, the method may include receiving a retransmission of the message on a second component carrier different than the first component carrier, where receiving the retransmission of the message on the second component carrier is based on the capability of the UE to support the cross-carrier HARQ retransmissions and one or more conditions associated with communications by the UE satisfying a threshold condition for the cross-carrier HARQ retransmissions. The operations of 1715 may be performed in accordance with examples as disclosed herein. In some examples, aspects of the operations of 1715 may be performed by an HARQ cross-carrier retransmission component 935 as described with reference to FIG. 9.

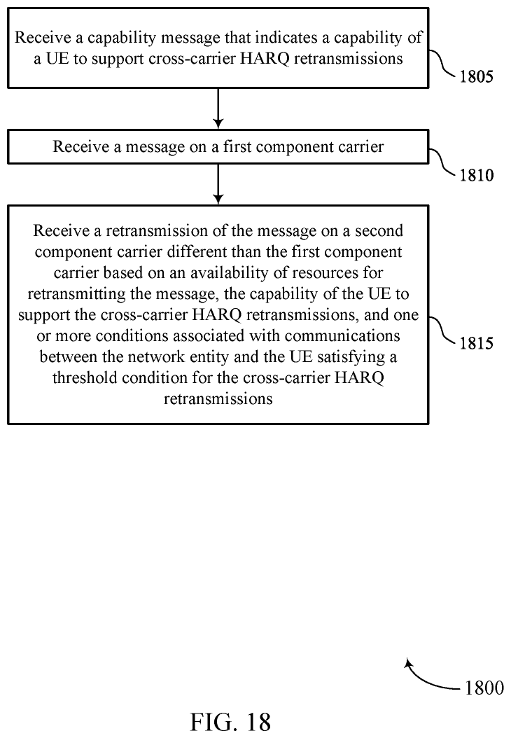

FIG. 18 illustrates a flowchart showing a method 1800 that supports conditional HARQ retransmission across carriers in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include receiving a capability message that indicates a capability of a UE to support cross-carrier HARQ retransmissions. The operations of 1805 may be performed in accordance with examples as disclosed herein. In some examples, aspects of the operations of 1805 may be performed by a cross-carrier HARQ capability component 1325 as described with reference to FIG. 13.

At 1810, the method may include receiving a message on a first component carrier. The operations of 1810 may be performed in accordance with examples as disclosed herein. In some examples, aspects of the operations of 1810 may be performed by an HARQ component 1330 as described with reference to FIG. 13.

At 1815, the method may include receiving a retransmission of the message on a second component carrier different than the first component carrier based on an availability of resources for retransmitting the message, the capability of the UE to support the cross-carrier HARQ retransmissions, and one or more conditions associated with communications between the network entity and the UE satisfying a threshold condition for the cross-carrier HARQ retransmissions. The operations of 1815 may be performed in accordance with examples as disclosed herein. In some examples, aspects of the operations of 1815 may be performed by an HARQ cross-carrier retransmission component 1335 as described with reference to FIG. 13.

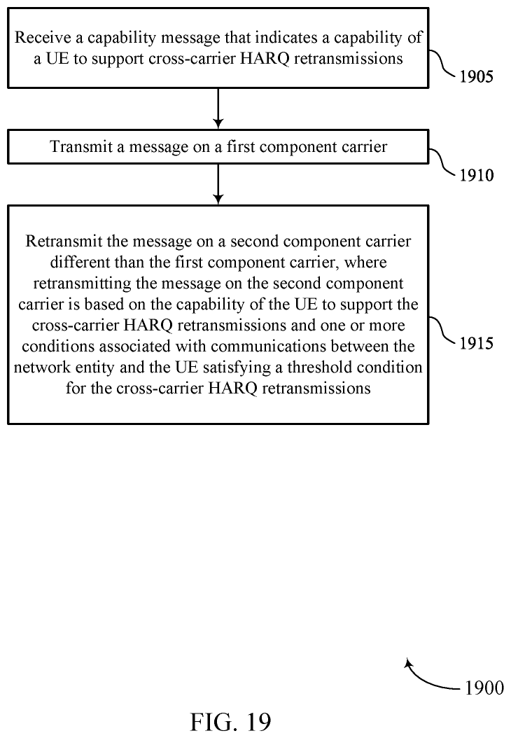

FIG. 19 illustrates a flowchart showing a method 1900 that supports conditional HARQ retransmission across carriers in accordance with one or more aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include receiving a capability message that indicates a capability of a UE to support cross-carrier HARQ retransmissions. The operations of 1905 may be performed in accordance with examples as disclosed herein. In some examples, aspects of the operations of 1905 may be performed by a cross-carrier HARQ capability component 1325 as described with reference to FIG. 13.

At 1910, the method may include transmitting a message on a first component carrier. The operations of 1910 may be performed in accordance with examples as disclosed herein. In some examples, aspects of the operations of 1910 may be performed by an HARQ component 1330 as described with reference to FIG. 13.

At 1915, the method may include retransmitting the message on a second component carrier different than the first component carrier, where retransmitting the message on the second component carrier is based on the capability of the UE to support the cross-carrier HARQ retransmissions and one or more conditions associated with communications between the network entity and the UE satisfying a threshold condition for the cross-carrier HARQ retransmissions. The operations of 1915 may be performed in accordance with examples as disclosed herein. In some examples, aspects of the operations of 1915 may be performed by an HARQ cross-carrier retransmission component 1335 as described with reference to FIG. 13.

The following provides an overview of aspects of the present disclosure:

Aspect 1: A method for wireless communication at a UE, comprising: transmitting a capability message that indicates a capability of the UE to support cross-carrier HARQ retransmissions; transmitting a message on a first component carrier; and retransmitting the message on a second component carrier different than the first component carrier based at least in part on an availability of resources for retransmitting the message, the capability of the UE to support the cross-carrier HARQ retransmissions, and one or more conditions associated with communications by the UE satisfying a threshold condition for the cross-carrier HARQ retransmissions.

Aspect 2: The method of aspect 1, further comprising: receiving a control message indicating a threshold uplink delay budget; and transmitting a second message indicating whether a remaining uplink delay budget of the UE satisfies the threshold uplink delay budget based at least in part on comparing the remaining uplink delay budget with the threshold uplink delay budget.

Aspect 3: The method of aspect 2, wherein retransmitting the message on the second component carrier is based at least in part on the second message indicating that the remaining uplink delay budget satisfies the threshold uplink delay budget.

Aspect 4: The method of any of aspects 1 through 3, further comprising: transmitting, via the capability message, an indication of a time period associated with preparing a retransmission of the message on the second component carrier, wherein retransmitting the message is based at least in part on the time period being less than a threshold time period.

Aspect 5: The method of any of aspects 1 through 4, further comprising: transmitting, via the capability message, an indication of a processing time associated with retransmissions by the UE.

Aspect 6: The method of any of aspects 1 through 5, further comprising: transmitting assistance information that indicates one or more parameters associated with the communications by the UE, wherein the one or more conditions are based at least in part on the one or more parameters indicated via the assistance information.

Aspect 7: The method of aspect 6, wherein the one or more parameters comprise a processing time associated with retransmissions by the UE, a status associated with a HARQ buffer at the UE, a quantity of cycles loaded at the UE, a quantity of processors loaded at the UE, or any combination thereof.

Aspect 8: The method of any of aspects 6 through 7, wherein transmitting the assistance information comprises: transmitting an RRC message that indicates the one or more parameters associated with the communications by the UE.

Aspect 9: The method of any of aspects 1 through 8, further comprising: transmitting a UCI message or a MAC-CE that indicates one or more parameters associated with the communications by the UE, wherein the one or more conditions are based at least in part on the one or more parameters indicated via the UCI message or the MAC-CE.

Aspect 10: The method of any of aspects 1 through 9, further comprising: transmitting assistance information comprising a request to enable the cross-carrier HARQ retransmissions based at least in part on a status associated with one or more processors of the UE satisfying a threshold processor status, wherein retransmitting the message on the second component carrier is based at least in part on the request.

Aspect 11: The method of any of aspects 1 through 10, further comprising: comparing an uplink PDCP queuing delay of the UE to a threshold PDCP queuing delay; transmitting UCI indicating that the uplink PDCP queuing delay satisfies the threshold PDCP queuing delay based at least in part on the comparing, the UCI being multiplexed with the message on the first component carrier; and receiving, on the first component carrier, a grant that indicates a transmission occasion for retransmitting the message on the second component carrier, wherein retransmitting the message is based at least in part on the grant and the uplink PDCP queuing delay satisfying the threshold PDCP queuing delay.

Aspect 12: The method of any of aspects 1 through 11, further comprising: receiving, based at least in part on the capability of the UE and the one or more conditions satisfying the threshold condition, a grant that indicates a transmission occasion for retransmitting the message on the second component carrier, wherein the message is retransmitted via the transmission occasion on the second component carrier based at least in part on the grant.

Aspect 13: The method of any of aspects 1 through 11, further comprising: receiving a control message that configures a set of configured grant resources for HARQ retransmissions on the first component carrier and the second component carrier, the set of configured grant resources comprising at least a first resource on the first component carrier for transmission of the message and a second resource on the second component carrier for at least one retransmission of the message, wherein retransmitting the message comprises: retransmitting the message via the second resource of the set of configured grant resources based at least in part on the capability of the UE and the one or more conditions satisfying the threshold condition.

Aspect 14: The method of any of aspects 1 through 11, further comprising: receiving a control message that configures a semi-static switching pattern for switching between the first component carrier and the second component carrier for at least one retransmission, wherein retransmitting the message on the second component carrier is based at least in part on the semi-static switching pattern.

Aspect 15: The method of aspect 14, further comprising: receiving, based at least in part on transmitting the message, DCI that indicates a request for a retransmission of the message, wherein retransmitting the message is based at least in part on the request, and wherein a carrier indication field in the DCI comprises information for the UE that is different than a carrier indication based at least in part on the semi-static switching pattern.

Aspect 16: The method of any of aspects 1 through 15, wherein the one or more conditions comprise a PER, an RSRP, or both measured by the UE.

Aspect 17: A method for wireless communication at a UE, comprising: transmitting a capability message that indicates a capability of the UE to support cross-carrier HARQ retransmissions; receiving a message on a first component carrier; and receiving a retransmission of the message on a second component carrier different than the first component carrier, wherein receiving the retransmission of the message on the second component carrier is based at least in part on the capability of the UE to support the cross-carrier HARQ retransmissions and one or more conditions associated with communications by the UE satisfying a threshold condition for the cross-carrier HARQ retransmissions.

Aspect 18: The method of aspect 17, further comprising: transmitting, via the capability message, an indication of a processing time associated with retransmissions by the UE.

Aspect 19: The method of any of aspects 17 through 18, further comprising: transmitting assistance information that indicates one or more parameters associated with communications by the UE, wherein the one or more conditions are based at least in part on the one or more parameters indicated via the assistance information.

Aspect 20: The method of aspect 19, wherein the one or more parameters comprise a processing time associated with retransmissions by the UE, a status associated with a HARQ buffer at the UE, a quantity of cycles loaded at the UE, a quantity of processors loaded at the UE, or any combination thereof.

Aspect 21: The method of any of aspects 19 through 20, wherein transmitting the assistance information comprises: transmitting an RRC message that indicates the one or more parameters associated with the communications by the UE.

Aspect 22: The method of any of aspects 17 through 21, further comprising: transmitting a UCI message or a MAC-CE that indicates one or more parameters associated with the communications by the UE, wherein the one or more conditions are based at least in part on the one or more parameters indicated via the UCI message or the MAC-CE.

Aspect 23: The method of any of aspects 17 through 22, further comprising: transmitting assistance information comprising a request to enable the cross-carrier HARQ retransmissions based at least in part on a status associated with one or more processors of the UE satisfying a threshold processor status, wherein receiving the retransmission of the message on the second component carrier is based at least in part on the request.

Aspect 24: The method of any of aspects 17 through 23, further comprising: receiving a grant that schedules a transmission occasion on the second component carrier for the retransmission of the message based at least in part on the one or more conditions satisfying the threshold condition, wherein the retransmission of the message is received via the transmission occasion on the second component carrier based at least in part on the grant.

Aspect 25: The method of any of aspects 17 through 23, further comprising: receiving a control message that configures a semi-static switching pattern for switching between the first component carrier and the second component carrier for at least one retransmission, wherein receiving the retransmission of the message on the second component carrier is based at least in part on the semi-static switching pattern.

Aspect 26: The method of aspect 25, further comprising: receiving, based at least in part on the message, DCI that indicates the retransmission of the message, wherein receiving the retransmission of the message is based at least in part on the DCI, and wherein a carrier indication field in the DCI comprises information for the UE that is different than a carrier indication based at least in part on the semi-static switching pattern.

Aspect 27: The method of any of aspects 17 through 26, wherein the one or more conditions comprise a PER, an RSRP, or both measured by the UE.

Aspect 28: A method for wireless communication at a network entity, comprising: receiving a capability message that indicates a capability of a UE to support cross-carrier HARQ retransmissions; receiving a message on a first component carrier; and receiving a retransmission of the message on a second component carrier different than the first component carrier based at least in part on an availability of resources for retransmitting the message, the capability of the UE to support the cross-carrier HARQ retransmissions, and one or more conditions associated with communications between the network entity and the UE satisfying a threshold condition for the cross-carrier HARQ retransmissions.

Aspect 29: The method of aspect 28, further comprising: transmitting a control message indicating a threshold uplink delay budget; and receiving a second message indicating whether a remaining uplink delay budget of the UE satisfies the threshold uplink delay budget, wherein receiving the retransmission of the message on the second component carrier is based at least in part on the second message indicating that the remaining uplink delay budget satisfies the threshold uplink delay budget.

Aspect 30: The method of any of aspects 28 through 29, further comprising: receiving, via the capability message, an indication of a time period associated with preparation, by the UE, of a retransmission of the message on the second component carrier, the time period based at least in part on a processing time associated with retransmissions by the UE, wherein receiving the retransmission of the message is based at least in part on the time period being less than a threshold time period.

Aspect 31: The method of any of aspects 28 through 30, further comprising: receiving assistance information that indicates one or more parameters associated with the communications by the UE, wherein the one or more conditions are based at least in part on the one or more parameters indicated via the assistance information.

Aspect 32: The method of aspect 31, wherein the one or more parameters comprise a processing time associated with retransmissions by the UE, a status associated with a HARQ buffer at the UE, a quantity of cycles loaded at the UE, a quantity of processors loaded at the UE, or any combination thereof.

Aspect 33: The method of any of aspects 31 through 32, wherein receiving the assistance information comprises: receiving a RRC message that indicates the one or more parameters associated with the communications by the UE.

Aspect 34: The method of any of aspects 28 through 33, further comprising: receiving an UCI message or a MAC-CE that indicates one or more parameters associated with the communications by the UE, wherein the one or more conditions are based at least in part on the one or more parameters indicated via the UCI message or the MAC-CE.

Aspect 35: The method of any of aspects 28 through 34, further comprising: receiving assistance information comprising a request to enable the cross-carrier HARQ retransmissions based at least in part on a status associated with one or more processors of the UE satisfying a threshold processor status, wherein receiving the retransmission of the message on the second component carrier is based at least in part on the request.

Aspect 36: The method of any of aspects 28 through 35, further comprising: receiving UCI indicating that an uplink PDCP queuing delay of the UE satisfies a threshold PDCP queuing delay, the UCI being multiplexed with the message on the first component carrier; and transmitting, on the first component carrier, a grant that indicates a transmission occasion for the retransmission of the message on the second component carrier, wherein the retransmission of the message is received based at least in part on the grant and the uplink PDCP queuing delay satisfying the threshold PDCP queuing delay.

Aspect 37: The method of any of aspects 28 through 36, further comprising: transmitting, based at least in part on the capability of the UE and the one or more conditions satisfying the threshold condition, a grant that indicates a transmission occasion for the retransmission of the message on the second component carrier, wherein the retransmission of the message is received via the transmission occasion on the second component carrier based at least in part on the grant.

Aspect 38: The method of any of aspects 28 through 36, further comprising: transmitting a control message that configures a set of configured grant resources for HARQ retransmissions on the first component carrier and the second component carrier, the set of configured grant resources comprising at least a first resource on the first component carrier for transmission of the message and a second resource on the second component carrier for at least one retransmission of the message, wherein the retransmission of the message is received via the second resource of the set of configured grant resources based at least in part on the capability of the UE and the one or more conditions satisfying the threshold condition.

Aspect 39: The method of any of aspects 28 through 36, further comprising: transmitting a control message that configures a semi-static switching pattern for switching between the first component carrier and the second component carrier for at least one retransmission, wherein receiving the retransmission of the message on the second component carrier is based at least in part on the semi-static switching pattern.

Aspect 40: The method of aspect 39, further comprising: transmitting, based at least in part on receiving the message, DCI that indicates a request for a retransmission of the message, wherein receiving the retransmission of the message is based at least in part on the request, and wherein a carrier indication field in the DCI comprises information for the UE that is different than a carrier indication based at least in part on the semi-static switching pattern.

Aspect 41: The method of any of aspects 28 through 40, wherein the one or more conditions comprise a PER, an RSRP, or both measured by the UE.

Aspect 42: A method for wireless communication at a network entity, comprising: receiving a capability message that indicates a capability of a UE to support cross-carrier HARQ retransmissions; transmitting a message on a first component carrier; and retransmitting the message on a second component carrier different than the first component carrier, wherein retransmitting the message on the second component carrier is based at least in part on the capability of the UE to support the cross-carrier HARQ retransmissions and one or more conditions associated with communications between the network entity and the UE satisfying a threshold condition for the cross-carrier HARQ retransmissions.

Aspect 43: The method of aspect 42, further comprising: receiving, via the capability message, an indication of a processing time associated with retransmissions by the UE.

Aspect 44: The method of any of aspects 42 through 43, further comprising: receiving assistance information that indicates one or more parameters associated with communications by the UE, wherein the one or more conditions are based at least in part on the one or more parameters indicated via the assistance information.

Aspect 45: The method of aspect 44, wherein the one or more parameters comprise a processing time associated with retransmissions by the UE, a status associated with a HARQ buffer at the UE, a quantity of cycles loaded at the UE, a quantity of processors loaded at the UE, or any combination thereof.

Aspect 46: The method of any of aspects 44 through 45, wherein receiving the assistance information comprises: receiving an RRC message that indicates the one or more parameters associated with the communications by the UE.

Aspect 47: The method of any of aspects 42 through 46, further comprising: receiving a UCI message or a MAC-CE that indicates one or more parameters associated with the communications by the UE, wherein the one or more conditions are based at least in part on the one or more parameters indicated via the UCI message or the MAC-CE.

Aspect 48: The method of any of aspects 42 through 47, further comprising: receiving assistance information comprising a request to enable the cross-carrier HARQ retransmissions based at least in part on a status associated with one or more processors of the UE satisfying a threshold processor status, wherein retransmitting the message on the second component carrier is based at least in part on the request.

Aspect 49: The method of any of aspects 42 through 48, further comprising: transmitting a grant that schedules a transmission occasion on the second component carrier for a retransmission of the message based at least in part on the one or more conditions satisfying the threshold condition, wherein the message is retransmitted via the transmission occasion on the second component carrier based at least in part on the grant.

Aspect 50: The method of any of aspects 42 through 48, further comprising: transmitting a control message that configures a semi-static switching pattern for switching between the first component carrier and the second component carrier for at least one retransmission, wherein retransmitting the message on the second component carrier is based at least in part on the semi-static switching pattern.

Aspect 51: The method of aspect 50, further comprising: transmitting, based at least in part on the message, DCI that indicates a retransmission of the message, wherein retransmitting the message is based at least in part on the DCI, and wherein a carrier indication field in the DCI comprises information for the UE that is different than a carrier indication based at least in part on the semi-static switching pattern.

Aspect 52: The method of any of aspects 42 through 51, wherein the one or more conditions comprise a PER, an RSRP, or both measured by the UE.

Aspect 53: An apparatus for wireless communication at a UE, comprising a processor; memory coupled with the processor; and instructions stored in the memory and executable by the processor to cause the apparatus to perform a method of any of aspects 1 through 16.

Aspect 54: An apparatus for wireless communication at a UE, comprising at least one means for performing a method of any of aspects 1 through 16.

Aspect 55: A non-transitory computer-readable medium storing code for wireless communication at a UE, the code comprising instructions executable by a processor to perform a method of any of aspects 1 through 16.

Aspect 56: An apparatus for wireless communication at a UE, comprising a processor; memory coupled with the processor; and instructions stored in the memory and executable by the processor to cause the apparatus to perform a method of any of aspects 17 through 27.

Aspect 57: An apparatus for wireless communication at a UE, comprising at least one means for performing a method of any of aspects 17 through 27.

Aspect 58: A non-transitory computer-readable medium storing code for wireless communication at a UE, the code comprising instructions executable by a processor to perform a method of any of aspects 17 through 27.

Aspect 59: An apparatus for wireless communication at a network entity, comprising a processor; memory coupled with the processor; and instructions stored in the memory and executable by the processor to cause the apparatus to perform a method of any of aspects 28 through 41.

Aspect 60: An apparatus for wireless communication at a network entity, comprising at least one means for performing a method of any of aspects 28 through 41.

Aspect 61: A non-transitory computer-readable medium storing code for wireless communication at a network entity, the code comprising instructions executable by a processor to perform a method of any of aspects 28 through 41.

Aspect 62: An apparatus for wireless communication at a network entity, comprising a processor; memory coupled with the processor; and instructions stored in the memory and executable by the processor to cause the apparatus to perform a method of any of aspects 42 through 52.

Aspect 63: An apparatus for wireless communication at a network entity, comprising at least one means for performing a method of any of aspects 42 through 52.

Aspect 64: A non-transitory computer-readable medium storing code for wireless communication at a network entity, the code comprising instructions executable by a processor to perform a method of any of aspects 42 through 52.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
transmit a capability message that indicates a capability of the UE to support cross-carrier hybrid automatic repeat request retransmissions;
transmit a message on a first component carrier; and
retransmit the message on a second component carrier different than the first component carrier based at least in part on an availability of resources for retransmitting the message, the capability of the UE to support the cross-carrier hybrid automatic repeat request retransmissions, and one or more conditions associated with communications by the UE satisfying a threshold condition for the cross-carrier hybrid automatic repeat request retransmissions.

2. The apparatus of claim 1, wherein the instructions are further executable by the processor to cause the apparatus to:
receive a control message indicating a threshold uplink delay budget; and
transmit a second message indicating whether a remaining uplink delay budget of the UE satisfies the threshold uplink delay budget based at least in part on comparing the remaining uplink delay budget with the threshold uplink delay budget.

3. The apparatus of claim 2, wherein retransmitting the message on the second component carrier is based at least in part on the second message indicating that the remaining uplink delay budget satisfies the threshold uplink delay budget.

4. The apparatus of claim 1, wherein the instructions are further executable by the processor to cause the apparatus to:
transmit, via the capability message, an indication of a time period associated with preparing a retransmission of the message on the second component carrier, wherein retransmitting the message is based at least in part on the time period being less than a threshold time period.

5. The apparatus of claim 1, wherein the instructions are further executable by the processor to cause the apparatus to:
transmit, via the capability message, an indication of a processing time associated with retransmissions by the UE.

6. The apparatus of claim 1, wherein the instructions are further executable by the processor to cause the apparatus to:
transmit transmitting assistance information that indicates one or more parameters associated with the communications by the UE, wherein the one or more conditions are based at least in part on the one or more parameters indicated via the assistance information.

7. The apparatus of claim 6, wherein the one or more parameters comprise a processing time associated with retransmissions by the UE, a status associated with a hybrid automatic repeat request buffer at the UE, a quantity of cycles loaded at the UE, a quantity of processors loaded at the UE, or any combination thereof.

8. The apparatus of claim 6, wherein the instructions to transmit the assistance information are executable by the processor to cause the apparatus to:
transmit a radio resource control message that indicates the one or more parameters associated with the communications by the UE.

9. The apparatus of claim 1, wherein the instructions are further executable by the processor to cause the apparatus to:
transmit an uplink control information message or a medium access control-control element that indicates one or more parameters associated with the communications by the UE, wherein the one or more conditions are based at least in part on the one or more parameters indicated via the uplink control information message or the medium access control-control element.

10. The apparatus of claim 1, wherein the instructions are further executable by the processor to cause the apparatus to:
transmit assistance information comprising a request to enable the cross-carrier hybrid automatic repeat request retransmissions based at least in part on a status associated with one or more processors of the UE satisfying a threshold processor status, wherein retransmitting the message on the second component carrier is based at least in part on the request.

11. The apparatus of claim 1, wherein the instructions are further executable by the processor to cause the apparatus to:
compare an uplink packet data convergence protocol (PDCP) queuing delay of the UE to a threshold PDCP queuing delay;
transmit uplink control information indicating that the uplink PDCP queuing delay satisfies the threshold PDCP queuing delay based at least in part on the comparing, the uplink control information being multiplexed with the message on the first component carrier; and
receive, on the first component carrier, a grant that indicates a transmission occasion for retransmitting the message on the second component carrier, wherein retransmitting the message is based at least in part on the grant and the uplink PDCP queuing delay satisfying the threshold PDCP queuing delay.

12. The apparatus of claim 1, wherein the instructions are further executable by the processor to cause the apparatus to:
receive, based at least in part on the capability of the UE and the one or more conditions satisfying the threshold condition, a grant that indicates a transmission occasion for retransmitting the message on the second component carrier, wherein the message is retransmitted via the transmission occasion on the second component carrier based at least in part on the grant.

13. The apparatus of claim 1, wherein the instructions are further executable by the processor to cause the apparatus to:
receive a control message that configures a set of configured grant resources for hybrid automatic repeat request retransmissions on the first component carrier and the second component carrier, the set of configured grant resources comprising at least a first resource on the first component carrier for transmission of the message and a second resource on the second component carrier for at least one retransmission of the message, and wherein, to retransmit the message, the instructions are further executable by the processor to cause the apparatus to:
retransmit the message via the second resource of the set of configured grant resources based at least in part on the capability of the UE and the one or more conditions satisfying the threshold condition.

14. The apparatus of claim 1, wherein the instructions are further executable by the processor to cause the apparatus to:
receive a control message that configures a semi-static switching pattern for switching between the first component carrier and the second component carrier for at least one retransmission, wherein retransmitting the message on the second component carrier is based at least in part on the semi-static switching pattern.

15. The apparatus of claim 14, wherein the instructions are further executable by the processor to cause the apparatus to:
receive, based at least in part on transmitting the message, downlink control information that indicates a request for a retransmission of the message, wherein retransmitting the message is based at least in part on the request, and wherein a carrier indication field in the downlink control information comprises information for the UE that is different than a carrier indication based at least in part on the semi-static switching pattern.

16. The apparatus of claim 1, wherein the one or more conditions comprise a packet error rate, a reference signal received power, or both measured by the UE.

17. An apparatus for wireless communication at a user equipment (UE), comprising:
a processor;
memory coupled with the processor; and
instructions stored in the memory and executable by the processor to cause the apparatus to:
transmit a capability message that indicates a capability of the UE to support cross-carrier hybrid automatic repeat request retransmissions;
receive a message on a first component carrier; and
receive a retransmission of the message on a second component carrier different than the first component carrier, wherein receiving the retransmission of the message on the second component carrier is based at least in part on the capability of the UE to support the cross-carrier hybrid automatic repeat request retransmissions and one or more conditions associated with communications by the UE satisfying a threshold condition for the cross-carrier hybrid automatic repeat request retransmissions.

18. The apparatus of claim 17, wherein the instructions are further executable by the processor to cause the apparatus to:
transmit, via the capability message, an indication of a processing time associated with retransmissions by the UE.

19. The apparatus of claim 17, wherein the instructions are further executable by the processor to cause the apparatus to:
transmit assistance information that indicates one or more parameters associated with communications by the UE, wherein the one or more conditions are based at least in part on the one or more parameters indicated via the assistance information.

20. The apparatus of claim 19, wherein the one or more parameters comprise a processing time associated with retransmissions by the UE, a status associated with a hybrid automatic repeat request buffer at the UE, a quantity of cycles loaded at the UE, a quantity of processors loaded at the UE, or any combination thereof.

21. The apparatus of claim 19, wherein the instructions to transmit the assistance information are executable by the processor to cause the apparatus to:
transmit a radio resource control message that indicates the one or more parameters associated with the communications by the UE.

22. The apparatus of claim 17, wherein the instructions are further executable by the processor to cause the apparatus to:
transmit an uplink control information message or a medium access control-control element that indicates one or more parameters associated with the communications by the UE, wherein the one or more conditions are based at least in part on the one or more parameters indicated via the uplink control information message or the medium access control-control element.

23. The apparatus of claim 17, wherein the instructions are further executable by the processor to cause the apparatus to:
transmit assistance information comprising a request to enable the cross-carrier hybrid automatic repeat request retransmissions based at least in part on a status associated with one or more processors of the UE satisfying a threshold processor status, wherein receiving the retransmission of the message on the second component carrier is based at least in part on the request.

24. The apparatus of claim 17, wherein the instructions are further executable by the processor to cause the apparatus to:
receive a grant that schedules a transmission occasion on the second component carrier for the retransmission of the message based at least in part on the one or more conditions satisfying the threshold condition, wherein the retransmission of the message is received via the transmission occasion on the second component carrier based at least in part on the grant.

25. The apparatus of claim 17, wherein the instructions are further executable by the processor to cause the apparatus to:
receive a control message that configures a semi-static switching pattern for switching between the first component carrier and the second component carrier for at least one retransmission, wherein receiving the retransmission of the message on the second component carrier is based at least in part on the semi-static switching pattern.

26. The apparatus of claim 25, wherein the instructions are further executable by the processor to cause the apparatus to:
receive, based at least in part on the message, downlink control information that indicates the retransmission of the message, wherein receiving the retransmission of the message is based at least in part on the downlink control information, and wherein a carrier indication field in the downlink control information comprises information for the UE that is different than a carrier indication based at least in part on the semi-static switching pattern.

27. An apparatus for wireless communication at a network entity, comprising:
a processor;
memory coupled with the processor; and
instructions stored in the memory and executable by the processor to cause the apparatus to:
receive a capability message that indicates a capability of a user equipment (UE) to support cross-carrier hybrid automatic repeat request retransmissions;
receive a message on a first component carrier; and
receive a retransmission of the message on a second component carrier different than the first component carrier based at least in part on an availability of resources for retransmitting the message, the capability of the UE to support the cross-carrier hybrid automatic repeat request retransmissions, and one or more conditions associated with communications between the network entity and the UE satisfying a threshold condition for the cross-carrier hybrid automatic repeat request retransmissions.

28. The apparatus of claim 27, wherein the instructions are further executable by the processor to cause the apparatus to:
transmit a control message indicating a threshold uplink delay budget; and
receive a second message indicating whether a remaining uplink delay budget of the UE satisfies the threshold uplink delay budget, wherein receiving the retransmission of the message on the second component carrier is based at least in part on the second message indicating that the remaining uplink delay budget satisfies the threshold uplink delay budget.

29. An apparatus for wireless communication at a network entity, comprising:
a processor;
memory coupled with the processor; and
instructions stored in the memory and executable by the processor to cause the apparatus to:
receive a capability message that indicates a capability of a user equipment (UE) to support cross-carrier hybrid automatic repeat request retransmissions;
transmit a message on a first component carrier; and
retransmit the message on a second component carrier different than the first component carrier, wherein retransmitting the message on the second component carrier is based at least in part on the capability of the UE to support the cross-carrier hybrid automatic repeat request retransmissions and one or more conditions associated with communications between the network entity and the UE satisfying a threshold condition for the cross-carrier hybrid automatic repeat request retransmissions.

30. The apparatus of claim 29, wherein the instructions are further executable by the processor to cause the apparatus to:
receive, via the capability message, an indication of a processing time associated with retransmissions by the UE.
